(19) United States
(12) Patent Application Publication
(10) Pub. No.: US 2025/0030928 A1
(43) Pub. Date: Jan. 23, 2025

(54) METHODS AND SYSTEMS FOR PREDICTING INTERRUPTIONS IN MEDIA CONTENT

(71) Applicant: TuneIn, Inc., San Francisco, CA (US)

(72) Inventors: Moksha Adyanthaya, San Francisco, CA (US); Abraham Ben-Tov, San Francisco, CA (US); Sarah Emerson, San Francisco, CA (US); Richard Stern, San Francisco, CA (US); Eric Wilcox, San Francisco, CA (US)

(21) Appl. No.: 18/735,289

(22) Filed: Jun. 6, 2024

Related U.S. Application Data
(60) Provisional application No. 63/514,678, filed on Jul. 20, 2023.

(51) Int. Cl. H04N 21/845; H04N 21/81

(52) U.S. Cl. CPC H04N 21/845; H04N 21/8113

(57) ABSTRACT

Disclosed embodiments may provide systems and methods for predicting interruptions in media content using machine-learning techniques and providing media content from alternative media sources in response to predicted interruptions. A computer-implemented method includes accessing initial media stream being presented by a user device. The initial media stream is associated with an initial media source. The computer-implemented method further includes identifying initial media content from the initial media stream. The computer-implemented method further includes applying a machine-learning model to the initial media stream to dynamically predict in real-time an interruption of the initial media content. The interruption is predicted as the initial media stream continues to be presented on the user device. The computer-implemented method further includes presenting a different media stream associated with an alternative media source, in which the different media stream is presented in response to the real-time predicted interruption.

### CROSS-REFERENCE TO RELATED APPLICATIONS

The present application claims benefit from U.S. Provisional Patent Application 63/514,678, filed Jul. 20, 2023, which is incorporated herein by reference in its entirety.

### TECHNICAL FIELD

This disclosure relates generally to methods and systems for predicting interruptions in media content, and more particularly to methods and systems for predicting interruptions in media content using machine-learning techniques and providing media content from alternative media sources in response to predicted interruptions.

### SUMMARY

Disclosed embodiments may provide systems and methods for predicting interruptions in media content using machine-learning techniques and providing media content from alternative media sources in response to predicted interruptions. According to some embodiments, a computer-implemented method is provided. The computer-implemented method includes accessing initial media stream being presented by a user device. The initial media stream is associated with an initial media source. The computer-implemented method further includes identifying initial media content from the initial media stream. The computer-implemented method further includes applying a machine-learning model to the initial media stream to dynamically predict in real-time an interruption of the initial media content. The interruption is predicted as the initial media stream continues to be presented. The computer-implemented method further includes presenting a different media stream associated with an alternative media source, in which the different media stream is presented in response to the real-time predicted interruption.

In some embodiments, the machine-learning model was trained using transfer learning.

In some embodiments, the alternative media source is associated with media content that substantially matches the initial media content of the initial media source.

In some embodiments, the computer-implemented method further includes applying the machine-learning model to the initial media stream to dynamically predict in real-time a conclusion of the interruption. The conclusion of the interruption is predicted as the different media stream continues to be presented by the user device.

In some embodiments, the computer-implemented method further includes generating a notification to be presented on the user device upon conclusion of the interruption. The notification includes an option to return to the initial media stream.

In some embodiments, the computer-implemented method further includes reverting to presenting the initial media stream upon conclusion of the interruption.

In some embodiments, the step of presenting the different media stream includes initiating a timer, wherein the user device reverts to presenting the initial media stream when the timer expires.

In some embodiments, the step of predicting the interruption includes applying a data-smoothing algorithm to two or more outputs generated by the machine-learning model.

In some embodiments, the initial media content includes music content, and the predicted real-time interruption includes non-music content.

In some embodiments, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Features, embodiments, and advantages of the present disclosure are better understood when the following Detailed Description is read with reference to the accompanying drawings.

FIG. 1 illustrates an example schematic diagram for temporarily replacing media content with different media content, according to some embodiments.

FIG. 2 illustrates an example computing environment for temporarily replacing media content with different media content, according to some embodiments.

FIG. 3 illustrates an example process for temporarily replacing media content with different media content, according to some embodiments.

FIG. 4 illustrates an example schematic diagram for predicting interruptions in media content using machine-learning techniques, according to some embodiments.

FIG. 5 illustrates an example computing environment for a user device predicting interruptions in media content using machine-learning techniques, according to some embodiments.

FIG. 6 illustrates an example computing environment for a content-provider system predicting interruptions in media content using machine-learning techniques, according to some embodiments.

FIG. 7 illustrates an example computing environment for a content-provider system predicting interruptions in media content based on output generated from a special-purpose computer, according to some embodiments.

FIG. 8 illustrates an example process for predicting interruptions in media content using machine-learning techniques, according to some embodiments.

FIG. 9 shows a computing system architecture, including various components in electrical communication with each other, in accordance with various embodiments

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

I. Systems and Methods for Temporarily Replacing Media Content with Different Media Content

Some embodiments of the present disclosure provide systems and methods for temporarily replacing media content broadcasted by a media source with different media content broadcasted by another media source. The temporary replacement of the media content can be performed by a user device interacting with one or more user-interface elements associated with a media-streaming application. For example, a user of the user device can identify that the initial media content had been interrupted with non-music content (e.g., a talk segment, an advertisement). In response to the interruption, the user can select a timer element of a user interface of the media-streaming application to initiate a timer and stream different media content broadcasted by other media source. Once the timer expires, the media-streaming application reverts to streaming the initial media content. Accordingly, the media-streaming application facilitates the users to temporarily replace the media content with different media content to avoid any potential interruptions to the preferred media content that is being consumed by the users.

### A. Example Implementation

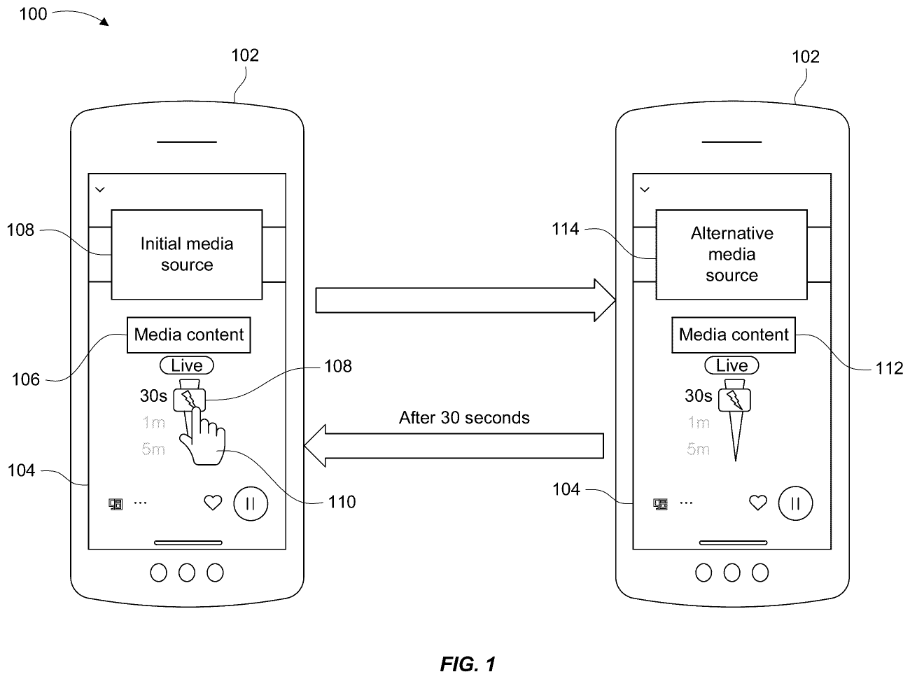

FIG. 1 illustrates an example schematic diagram 100 for temporarily replacing media content with different media content, according to some embodiments. In FIG. 1, a user device 102 provides a user interface 104 of a media-streaming application for presenting media content 106 broadcasted by an initial media source 108. As an illustrative example, the media-streaming application can stream music broadcasted by a classical music radio station in New York. The user can interact with the user interface 104 to play or stop the music broadcasted from the New York classical music radio station. In some instances, the user interacts with the user interface 104 to select another media source to stream different media content. The examples presented in FIG. 1 provides the user device 102 streaming music content, but the user device 102 can also be configured to provide other types of media content including video, video games, virtual reality, augmented reality, and the like.

The user interface 104 can also include a timer element 108, which can initiate a timer in response to a user selection 110. The timer element 108 facilitate the media-streaming application to temporarily replace the media content 106 with another media content 112 broadcasted by an alternative media source 114. For example, the user selection 110 of the timer element 108 triggers the media-streaming application to present the other media content 112 for 30 seconds. When the timer 108 expires, the media-streaming application can revert to presenting the media content 106 from the initial media source 108. Continuing with the example, the timer element 108 indicates the media content 106 to be replaced for 30 seconds. After the other media content 112 is presented on the user interface 104 for 30 seconds, the media-streaming application reverts to presenting the initial media content 106 broadcasted by the initial media source 108. In some instances, the time element 108 can be adjusted to select a time length for the timer, in which the media-streaming application presents the other media content 112 for the duration of the selected time length. For example, the timer element 108 can incorporate a slider feature, in which the user can slide down the timer element 108 to modify the time length from 30 seconds to 5 minutes. The length of time that can be set by the timer element 108 is not limited to 30 seconds, 1 minute, and 5 minutes, as shown in FIG. 1. Rather, the time length for the timer can include 1 second, 5 seconds, 10 seconds, 15 seconds, 20 seconds, 25 seconds, 30 seconds, 35 seconds, 40 seconds, 45 seconds, 50 seconds, 55 seconds, 1 minute, 2 minutes, 3 minutes, 4 minutes, 5 minutes, 10 minutes, and more than 10 minutes.

In some instances, media sources can be grouped together, such that the media content 112 can provide substantially similar media content to the media content 106 when the timer element 108 is activated. For example, a first group of media sources can provide sports-news content, a second group of media sources can provide classical-rock content, a third group of media source can provide documentary video content, and the like. As the user selects a particular music source provided by the media-streaming application, a corresponding group of media sources are presented together to allow the user to switch (e.g., via user selection, via use of the timer element 108) between different media sources to access similar media content. The association between the media sources can be predetermined by the content provider based on historical data from users that utilize the media-streaming application, locations at which the media sources are broadcasted, etc. In some instances, the media sources are grouped together by analyzing the respective metadata of the media streams. For example, the metadata from a particular media stream can identify that the alternative media source 114 is a classical music radio station based on San Francisco, which can be grouped with the media source 108 in New York that broadcasts classical music.

The timer 108 thus allows the temporary presentation of the different media content (e.g., the media content 112). In some instances, the timer element 108 can be used to deactivate the timer to allow the media content 112 to be presented without reverting back to the initial media stream 106 of the initial media source 108.

B. Computing Environment for Temporarily Replacing Media Content with Different Media Content

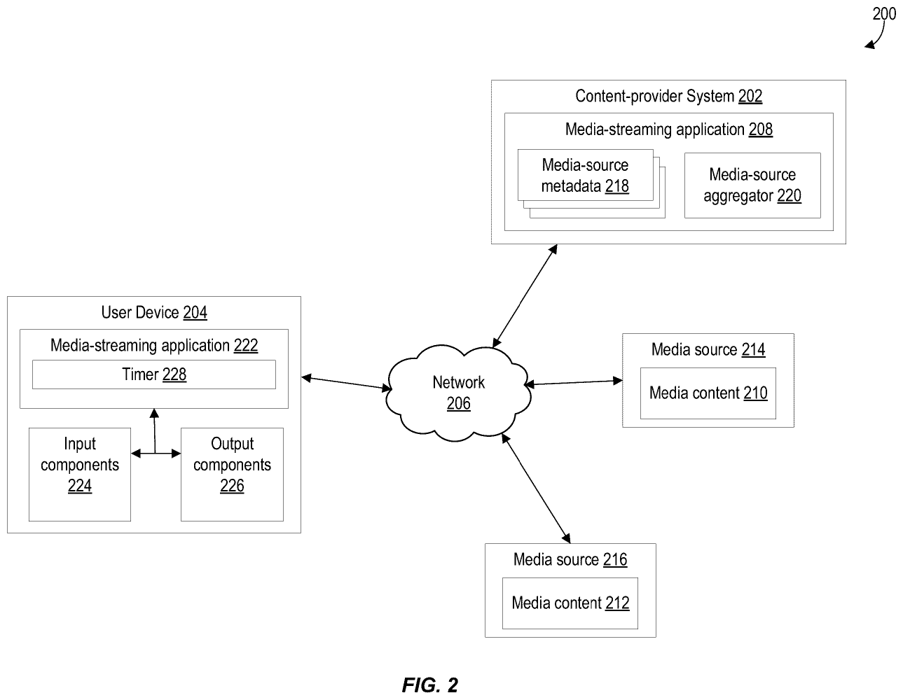

FIG. 2 illustrates an example computing environment 200 for temporarily replacing media content with different media content, according to some embodiments. In FIG. 2, a content-provider system 202 may include hardware and/or software components that operate within a distributed environment to stream media content to one or more user devices (e.g., a user device 204) over a communication network 206. The content-provider system 202 can store and execute a server-side media-streaming application 208, which may be configured to stream media content 210 and 212 broadcasted from various media sources (e.g., media sources 214 and 216). To facilitate streaming of media content, the server-side media-streaming application 208 can access various data from the user device 204 (e.g., a computing device, an in-vehicle entertainment system, a mobile device, or the like). For example, the media-streaming application 208 can access past browsing history of the user device 204 and user profile data of the user device 204 to identify a set of default media sources for streaming media content to the user device 204. In some instances, when operating in a distributed environment, the content-provider system 202 may include executable processes in which some processes may be executed by the user device 204 and some processes may be executed by the server 202.

The media-streaming application 208 may receive media streams corresponding to the media content 212 and 214 (e.g., such, but not limited to a radio broadcast) over the network 206 (e.g., a cloud network, a local area network, a wide area network, the Internet, etc.). The media streams may be transmitted or broadcasted by the media sources 214 and 216 (e.g., physical location from which a media stream is broadcasted or transmitted such as, but not limited to, a radio station). The media-streaming application 208 can process the media streams to present the corresponding media content to the user device 204. In some instances, the media streams are transmitted to the user device in a specific file format. For example, the media streams can be transmitted in audio file format, including but not limited to M4A, FLAC, MP3, MP4, WAV, WMA, and AAC file formats. In another example, the media streams can be transmitted in a video file format, including but not limited to MP4, MOV, AVI, WMV, AVCHD, WebM, and FLV.

The content-provider system 202 may include processing hardware (e.g., one or more processors such as CPU, memory, input components, output components, etc.) and a processor. The processor may include hardware components (e.g., media processor, other processors, memory, etc.) and/or software processes that execute to provide the functionality of the media-streaming application 208. The content-provider system 202 can also include one or more database that store media-source metadata 218 that include data for identifying media content broadcasted by a media source, a genre of the media content, a program schedule of content included in the media content, location of the media source, and/or the like.

In some instances, a media-source aggregator 220 stores groups of media sources that provide substantially similar media content. For example, the media-source aggregator 220 stores a first group of media sources that provide sports-news content, a second group of media sources that provide classical-rock content, and the like. As the user device 204 selects a particular music source provided by the media-streaming application 208, a corresponding group of media sources are presented together to allow the user to switch between different media sources to access similar media content. The association between the media sources can be predetermined by the content provider based on historical data from users that utilize the media-streaming application, locations at which the media sources are broadcasted, etc. In some instances, the media sources are grouped together by analyzing the respective metadata of the media streams. For example, the metadata from a particular media stream can identify that the media source is a classical music radio station based on San Francisco, which can be grouped with a media source in New York that broadcasts classical music.

The user-device 204 can also include processing hardware (e.g., one or more processors such as CPU, memory, input components, output components, etc.) and a processor. The processor may include hardware components (e.g., media processor, other processors, memory, etc.) and/or software processes that execute to receive the media stream from the content-provider system 202 and present the media stream to provide media content for a user. The user-device 204 also include a client-side media-streaming application 222, input components 224, and output components 212. The media-streaming application 222 can be configured to predict media-content interruptions in real-time and stream different media content from alternative media sources the user device during such interruptions. To enable user interaction with the media-streaming application 222, the input components 224 can be utilized, which can include a microphone for speech, a touch-sensitive screen for gesture or graphical input, keyboard, mouse, motion input, pen, and other such input devices. In addition, the media content from the media source can be outputted using the output components 226, which can include, but not limited to, monitors, speakers, printers, haptic devices, and other such output devices.

In some instances, the user device 204 interacts with the media-streaming application 222 through a user interface to identify media sources and access their respective media streams. The user interface may display one or more user interface elements that identify the media content presented, being presented, and/or to be presented by the user device (e.g., the media content 210), as well as the media source corresponding to the media content (e.g., the media source 214). The user input may be received using the input components 224 to select an icon that represents a media source, which triggers the media content to be presented on the user device 204 via the output components 226 (e.g., speaker, display screen).

The user device 204 can also include a timer 228, which can be initiated to temporarily replace the media content 210 with another media content 212 broadcasted by an alternative media source 216. For example, the timer 228 can be initiated such that the media-streaming application 222 presents the other media content 212 for 30 seconds. When the timer 228 expires, the media-streaming application 222 can revert to presenting the media content 210 from the initial media source 214. For example, the timer 228 can indicate the different media content 212 to be replaced for 5 minutes. After the other media content 212 is presented by the media-streaming application 222 for 5 minutes, the media-streaming application 222 reverts to presenting the initial media content 210 broadcasted by the initial media source 214. In some instances, the timer 228 can be configured to select a time length, in which the media-streaming application presents the other media content 212 for the duration of the selected time length. In some embodiments, the time length for the timer includes 1 second, 5 seconds, 10 seconds, 15 seconds, 20 seconds, 25 seconds, 30 seconds, 35 seconds, 40 seconds, 45 seconds, 50 seconds, 55 seconds, 1 minute, 2 minutes, 3 minutes, 4 minutes, 5 minutes, 10 minutes, and more than 10 minutes.

C. Methods for Temporarily Replacing Media Content with Different Media Content

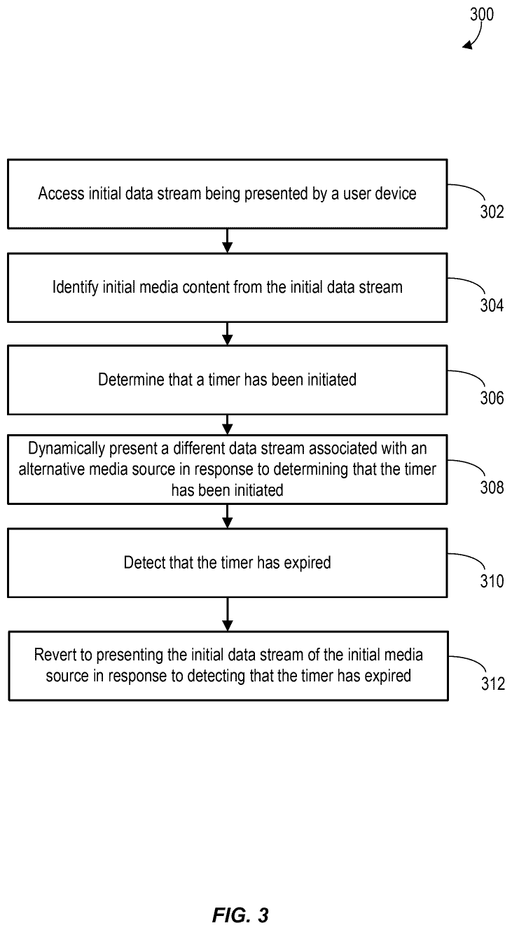

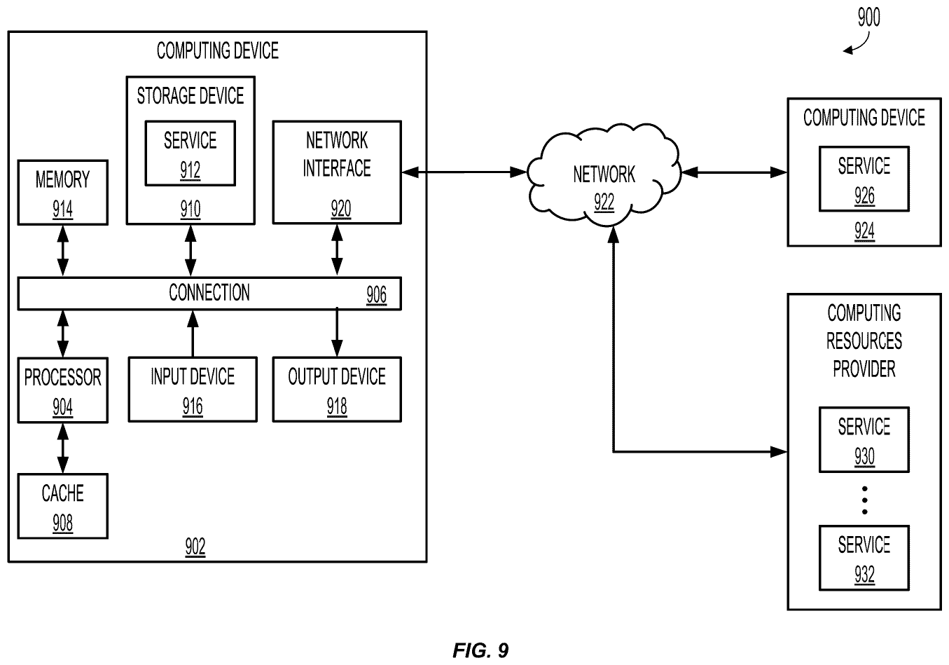

FIG. 3 illustrates an example process 300 for temporarily replacing media content with different media content, according to some embodiments. For illustrative purposes, the process 300 is described with reference to the components illustrated in FIGS. 1-2, though other implementations are possible. For example, the program code for the media-streaming application of FIGS. 1-2, is executed by one or more processing devices to cause a server system (e.g., the computing device 902 of FIG. 9) to perform one or more operations described herein.

At step 302, a media-streaming application (e.g., the media-streaming application 222 of FIG. 2) can access initial media stream being presented by a user device. The media stream can include data being transmitted by a media source (e.g., a radio station) to the user device across a time period. The initial media stream can include media content (e.g., video, audio) and can be associated with an initial media source. As an illustrative example, the media-streaming application can be installed in the user device, in which the media-streaming application provides an interface that facilitates streaming of music broadcasted by a classical music radio station in New York. In another example, the user device can launch an internet browser to access a website of a content provider that stores the media-streaming application. A user can then interact with one or more interface elements of the website to stream the music broadcasted from the New York classical music radio station. In both examples, the media-streaming application can access the initial media stream as the music is being broadcasted from the initial media source (e.g., the New York classical music radio station) to the user device.

In addition to media content, the initial media stream can additionally include other types of data. For example, the initial media stream can include metadata for use in identifying the media content and/or media sources broadcasting the media content. Examples of metadata may include, but are not limited to, a genre, a song, an artist, an album, a media presentation (e.g., a concert, television show, movie, etc.), an identification of historical media streams (e.g., within a predetermined time interval such as past day, year, etc. or with any time interval), a media source (e.g., radio station), a location (e.g., a country, a state, a region, a city, an address, etc., a context (e.g., such as a concept, emotion, an experience, and/or the like), or the like.

At step 304, the media-streaming application can identify initial media content (e.g., music, video) from the initial media stream. The initial media content can include music content. In some instances, the media-streaming application identifies an initial topic or genre (e.g., classical music, Beethoven music) of the initial media content. The media-streaming application can identify the initial media content based on the metadata of the initial media stream. Continuing with the example, the media-streaming application can parse the metadata of the initial media stream to determine that the classical music radio station is playing “Moonlight Sonata.” Based on the metadata, the media-streaming application can identify the classical-music content from the initial media stream. The identification of the initial media content can be performed in real-time as the content of the initial media stream continues to be presented on the user device. In some instances, the media-streaming application displays the initial media content and the corresponding media source on a user interface (e.g., the user interface 104 of FIG. 1) of a user device.

At step 306, the media-streaming application can determine that a timer has been initiated, as the initial media stream continues to be presented by the user device. The timer can be initiated to temporarily replace the initial media content with another media content broadcasted by an alternative media source. For example, the timer can be initiated such that the media-streaming application presents the other media content for 30 seconds. When the timer expires, the media-streaming application can revert to presenting the media content from the initial media source. For example, the timer can indicate the different media content to be replaced for 5 minutes. After the other media content is presented by the media-streaming application for 5 minutes, the media-streaming application reverts to presenting the initial media content broadcasted by the initial media source. In some instances, the timer can be configured to select a time length, in which the media-streaming application presents the other media content for the duration of the selected time length. In some embodiments, the time length for the timer includes 1 second, 5 seconds, 10 seconds, 15 seconds, 20 seconds, 25 seconds, 30 seconds, 35 seconds, 40 seconds, 45 seconds, 50 seconds, 55 seconds, 1 minute, 2 minutes, 3 minutes, 4 minutes, 5 minutes, 10 minutes, and more than 10 minutes. Additionally or alternatively, the time length of the timer can be indefinite, which triggers the media-streaming application to present different media content without reverting to the initial media stream.

At step 308, the media-streaming application can dynamically present a different media stream associated with an alternative media source in response to determining that the timer has been initiated. For example, once the timer has been initiated, the media-streaming application can dynamically switch to the media stream being broadcasted by a classical music radio station in San Francisco. The different media stream can include its media content (e.g., “Fur Elise” composed by Ludwig van Beethoven) that may be substantially similar with the initial media content. Once the timer has been initiated, the media-streaming application begins countdown of the timer for the specified time length. In some instances, the media-streaming application displays the streamed media content and the alternative media source on the user interface of the user device.

In some instances, the alternative media source is associated with media content that substantially matches the initial media content of the initial media source. For example, the media content from the alternative media source may also include classical music (e.g., Pachebel's Canon), which can be similar with the “Moonlight Sonata” that was initially streamed on the user device. The association between the initial media source and the alternative media source can be predetermined by a content provider based on historical data from users that utilize the media-streaming application. Additionally or alternatively, the alternative media source can be identified as being substantially similar to the initial data source by analyzing the respective metadata of the media streams. For example, the metadata from the different media stream can indicate that the alternative media source is another classical music radio stations based on San Francisco, which is substantially similar with the classical music radio station in New York.

At step 310, the media-streaming application can detect that the timer has expired. In some instances, the media-streaming application temporarily stores an identifier associated with the initial media source in the memory (e.g., a random-access memory), as the media-streaming application continues to present the different media stream. In some instances, the user may deactivate the timer before it expires, such that the media-streaming application continues to present the different media stream and does not revert to presenting the initial media stream.

At step 312, the media-streaming application can revert to presenting the initial media stream of the initial media source in response to detecting that the timer has expired. For example, once the timer has expired, the media-streaming application accesses the identifier of the initial media source in the memory. The media-streaming application then reestablishes the connection with the initial media source based on the identifier, such that the initial media source rebroadcasts media content on the user device. Process 300 terminates thereafter.

### II. Machine-Learning Techniques for Predicting Interruptions in Media Content

In addition to allowing users to temporarily replace an initial media content broadcasted from an initial media source with different media content, some embodiments of the present disclosure provide methods and systems for automatically predicting interruptions in the initial media content (e.g., non-music content) using machine-learning techniques. In response to predicting the presence of interruptions, media content broadcasted from different media sources can be presented during such interruptions. In some instances, the media-streaming application predicts conclusion of the interruption to allow the user device to revert back to presenting the initial media content. The real-time interruption prediction and switching of media sources allow the users to listen or view the media content with minimal interruptions and distractions.

### A. Example Implementation

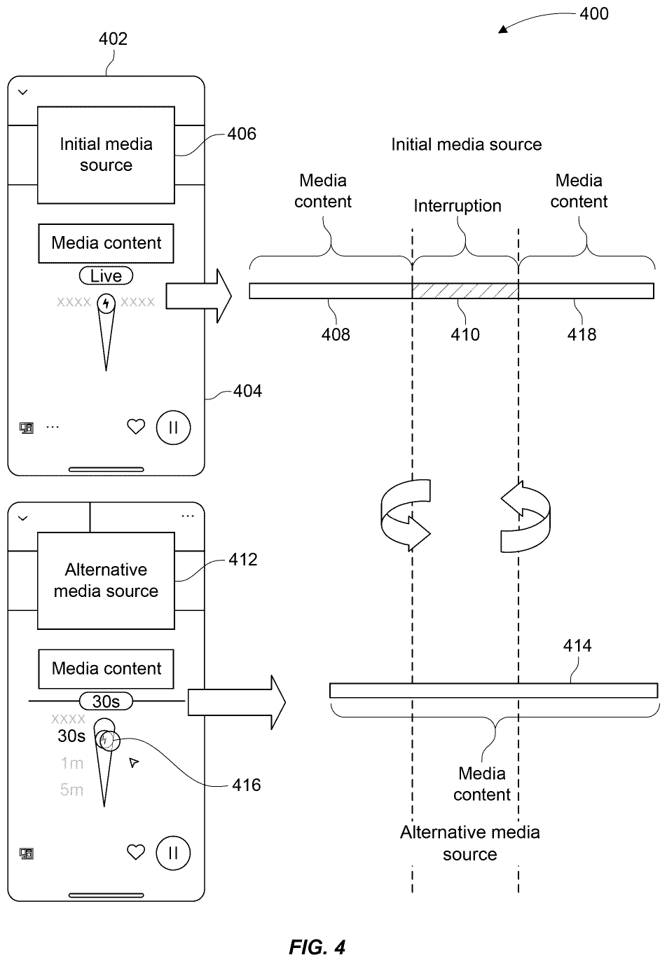

FIG. 4 illustrates an example schematic diagram 400 for predicting interruptions in media content using machine-learning techniques, according to some embodiments. A media-streaming application 402 can access initial media stream being presented by a user device 404. The media stream can include data being transmitted by a media source (e.g., a radio station) to the user device across a time period. The initial media stream can include media content (e.g., video, audio) and can be associated with an initial media source 406. As an illustrative example, the media-streaming application can be installed in the user device, in which the media-streaming application provides an interface that facilitates streaming of music broadcasted by a classical music radio station in New York. In another example, the user device can launch an internet browser to access a website of a content provider that stores the media-streaming application. A user can then interact with one or more interface elements of the website to stream the music broadcasted from the New York classical music radio station. In both examples, the media-streaming application can access the initial media stream as the music is being broadcasted from the initial media source (e.g., the New York classical music radio station) to the user device.

In addition to media content, the initial media stream can additionally include other types of data. For example, the initial media stream can include metadata for use in identifying the media content and/or media sources broadcasting the media content. Examples of metadata may include, but are not limited to, a genre, a song, an artist, an album, a media presentation (e.g., a concert, television show, movie, etc.), an identification of historical media streams (e.g., within a predetermined time interval such as past day, year, etc. or with any time interval), a media source (e.g., radio station), a location (e.g., a country, a state, a region, a city, an address, etc., a context (e.g., such as a concept, emotion, an experience, and/or the like), or the like.

The media-streaming application can identify initial media content 408 (e.g., music, video) from the initial media stream. The initial media content 408 can include music content. In some instances, the media-streaming application identifies an initial topic or genre (e.g., classical music, Beethoven music) of the initial media content 408. The media-streaming application can identify the initial media content 408 based on the metadata of the initial media stream. Continuing with the example, the media-streaming application can parse the metadata of the initial media stream to determine that the classical music radio station is playing “Moonlight Sonata.” Based on the metadata, the media-streaming application can identify the classical-music content from the initial media stream. The identification of the initial media content 408 can be performed in real-time as the content of the initial media stream continues to be presented on the user device 404.

In some instances, the media-streaming application identifies the initial media content 408 by using machine-learning techniques. For example, the media-streaming application can define a set of media segments (e.g., 1-second media segments) for a first time window of the initial media stream. For each media segment of the first time window, the media-streaming application can apply a machine-learning model to the media segment to generate a classification that indicates whether the given media segment corresponds to the initial media content 408. If the machine-learning model outputs consecutive classifications that the segments correspond to the initial media content (e.g., five or more consecutive classifications), the media-streaming application can determine that the initial media stream includes the initial media content 408 for the first time window. In some instances, the media-streaming application additionally identifies an initial topic or genre by using the metadata from the initial media stream and/or by applying the machine-learning model.

Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods.

In some instances, the machine-learning model was trained using training data received and/or derived from media streams previously presented by the user device. Each data item of the training data can be labeled as either corresponding to media content or as non-media content. In some instances, the machine-learning model was trained using media streams associated other user devices (e.g., such as other devices executing the media-streaming application). Additionally or alternatively, the machine-learning model can be trained to predict a genre or topic associated with the media content, in which each data item of the training data can be labeled as corresponding to a particular genre or topic of the media content. The machine-learning model can be trained using supervised training, supervised training, semi-supervised training, reinforcement training, combinations thereof, or the like. For example, the machine-learning model was trained using transfer learning.

The media-streaming application can apply the machine-learning model to the initial media stream to dynamically predict in real-time an interruption 410 of the initial media content. In particular, the interruption 410 is predicted in real-time as media content of the initial media stream continues to be presented on the user device. Continuing with the example, the media-streaming application can apply the machine-learning model to the initial media stream to predict that: (i) the song “Moonlight Sonata” has ended; and (ii) the broadcast is now streaming an advertisement. The predicted real-time interruption can include non-music content. For example, the non-music content can include an advertisement, a narration segment, a talk-show segment, and the like. In some instances, the predicted real-time interruption can include media content corresponding to a different genre or topic (e.g., news segment) from the initial genre or topic of the initial media content (e.g., classical music content). Additionally or alternatively, the predicted real-time interruption can include a network-connection loss from the initial media source.

As noted above, the interruption 410 can be predicted using machine-learning techniques. For each media segment of a set of media segments for a second time window of the initial media stream, the media-streaming application can apply the machine-learning model to the media segment to generate a classification that indicates whether the given media segment corresponds to the initial media content. If the machine-learning model outputs consecutive classifications that the media segments do not correspond to the initial media content, the media-streaming application can determine that the initial media content had been interrupted for the second time window. The consecutive classifications can reduce data noise and potential false positives, which in turn increases accuracy and consistency of predicting interruptions in the media content. The determination of the interruption can be performed as the user device continues to present the media content of the initial media stream. In some instances, predicting the interruption includes applying a data-smoothing algorithm to two or more outputs generated by the machine-learning model. The data-smoothing algorithm can be used to remove any noise or outliers associated with the initial media stream, such that the media-content classifications can be improved.

In response to the real-time predicted interruption 410, the media-streaming application can dynamically present a different media stream associated with an alternative media source 412, in which different media stream includes different music content 414. For example, once the interruption has been predicted, the media-streaming application can dynamically switch to the media stream being broadcasted by a classical music radio station in San Francisco. The switching of media streams allows the media content to be presented before or as soon as the interruption occurs in the user device. In some instances, the media-streaming application initiates a timer 416. When the timer 416 expires, the user device can revert to presenting the initial media stream. The timer allows the temporary presentation of the different media stream (i.e., different media content). Additionally or alternatively, the timer 416 can be deactivated by the user to allow the different media stream to be presented without reverting back to the initial media stream.

In some instances, the alternative media source 412 is associated with media content that substantially matches the initial media content of the initial media source 406. The association between the initial media source and the alternative media source can be predetermined by the content provider based on historical data from users that utilize the media-streaming application. Additionally or alternatively, the alternative media source can be identified as being substantially similar to the initial data source by analyzing the respective metadata of the media streams. For example, the metadata from the different media stream can indicate that the alternative media source is another classical music radio stations based on San Francisco, which is substantially similar with the classical music radio station in New York.

In some instances, the media-streaming application applies the machine-learning model to the initial media stream to dynamically predict in real-time a conclusion of the interruption. The conclusion of the interruption can include the initial media source ending the interruption and rebroadcasting the initial media content. In some instances, the conclusion of the interruption includes the initial media source broadcasting media content 418 having a genre or topic (e.g., jazz music) that is substantially similar to the initial genre or topic of the initial media content (e.g., classical music). The conclusion of the interruption is predicted using machine learning, while the different media stream continues to be presented by the user device. For example, for each media segment of a set of media segments for a third time window of the initial media stream, the media-streaming application can apply the machine-learning model to the media segment to generate a classification that indicates whether the given media segment corresponds to the initial media content. If the machine-learning model outputs consecutive classifications that the media segments correspond to the initial media content, the media-streaming application can determine the conclusion of the interruption for the third time window.

The media-streaming application can generate a notification to be presented on the user device upon conclusion of the interruption. The notification can include a selectable option for the user device to stream the media content from the initial media source. For example, once the advertisement ends for the New York radio station, the media-streaming application can generate a notification that prompts whether the user is interested in returning to the media content broadcasted New York radio station. The user can either respond to the notification by returning to the New York radio station or permanently switching to the San Francisco radio station. In some instances, the media-streaming application automatically reverts to presenting the initial media stream upon conclusion of the interruption, which can be performed without providing prompts to the user device.

### B. Machine-Learning Techniques for a User Device Predicting Interruptions in Media Content

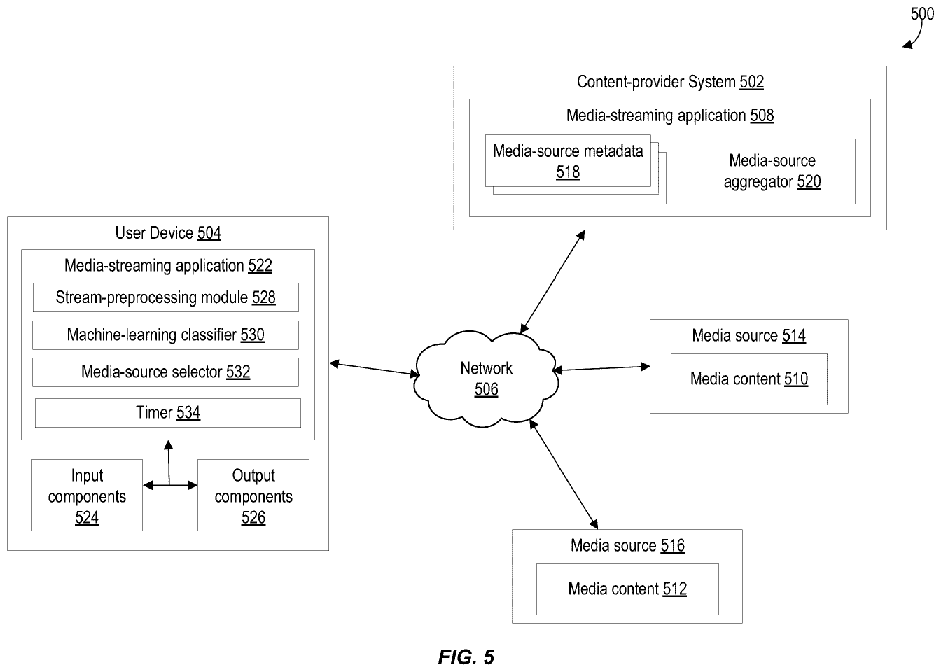

FIG. 5 illustrates an example computing environment 500 for a user device predicting interruptions in media content using machine-learning techniques, according to some embodiments. In FIG. 5, a content-provider system 502 may include hardware and/or software components that operate within a distributed environment to stream media content to one or more user devices (e.g., a user device 504) over a communication network 506. The content-provider system 502 can store and execute a server-side media-streaming application 508, which may be configured to stream media content 510 and 512 broadcasted from various media sources (e.g., media sources 514 and 516). To facilitate streaming of media content, the server-side media-streaming application 508 can access various data from the user device 504 (e.g., a computing device, an in-vehicle entertainment system, a mobile device, or the like). For example, the media-streaming application 508 can access past browsing history of the user device 504 and user profile data of the user device 504 to identify a set of default media sources for streaming media content to the user device 504. In some instances, when operating in a distributed environment, the content-provider system 502 may include executable processes in which some processes may be executed by the user device 504 and some processes may be executed by the server 502.

The media-streaming application 508 may receive media streams corresponding to the media content 512 and 514 (e.g., such, but not limited to a radio broadcast) over the network 506 (e.g., a cloud network, a local area network, a wide area network, the Internet, etc.). The media streams may be transmitted or broadcasted by the media sources 514 and 516 (e.g., physical location from which a media stream is broadcasted or transmitted such as, but not limited to, a radio station). The media-streaming application 508 can process the media streams to present the corresponding media content to the user device 504. In some instances, the media streams are transmitted to the user device in a specific file format. For example, the media streams can be transmitted in audio file format, including but not limited to M4A, FLAC, MP3, MP4, WAV, WMA, and AAC file formats. In another example, the media streams can be transmitted in a video file format, including but not limited to MP4, MOV, AVI, WMV, AVCHD, WebM, and FLV.

The content-provider system 502 may include processing hardware (e.g., one or more processors such as CPU, memory, input components, output components, etc.) and a processor. The processor may include hardware components (e.g., media processor, other processors, memory, etc.) and/or software processes that execute to provide the functionality of the media-streaming application 508. The content-provider system 502 can also include one or more database that store media-source metadata 518 that include data for identifying media content broadcasted by a media source, a genre of the media content, a program schedule of content included in the media content, location of the media source, and/or the like.

In some instances, a media-source aggregator 520 stores groups of media sources that provide substantially similar media content. For example, the media-source aggregator 520 stores a first group of media sources that provide sports-news content, a second group of media sources that provide classical-rock content, and the like. As the user device 504 selects a particular music source provided by the media-streaming application 508, a corresponding group of media sources are presented together to allow the user to switch between different media sources to access similar media content. The association between the media sources can be predetermined by the content provider based on historical data from users that utilize the media-streaming application, locations at which the media sources are broadcasted, etc. In some instances, the media sources are grouped together by analyzing the respective metadata of the media streams. For example, the metadata from a particular media stream can identify that the media source is a classical music radio station based on San Francisco, which can be grouped with a media source in New York that broadcasts classical music.

The user-device 504 can also include processing hardware (e.g., one or more processors such as CPU, memory, input components, output components, etc.) and a processor. The processor may include hardware components (e.g., media processor, other processors, memory, etc.) and/or software processes that execute to receive the media stream from the content-provider system 502 and present the media stream to provide media content for a user. The user-device 504 also include a client-side media-streaming application 522, input components 524, and output components 512. The media-streaming application 522 can be configured to predict media-content interruptions in real-time and stream different media content from alternative media sources the user device during such interruptions. To enable user interaction with the media-streaming application 522, the input components 524 can be utilized, which can include a microphone for speech, a touch-sensitive screen for gesture or graphical input, keyboard, mouse, motion input, pen, and other such input devices. In addition, the media content from the media source can be outputted using the output components 526, which can include, but not limited to, monitors, speakers, printers, haptic devices, and other such output devices.

In some instances, the user device 504 interacts with the media-streaming application 522 through a user interface to identify media sources and access their respective media streams. The user interface may display one or more user interface elements that identify the media content presented, being presented, and/or to be presented by the user device (e.g., the media content 510), as well as the media source corresponding to the media content (e.g., the media source 514). The user input may be received using the input components 524 to select an icon that represents a media source, which triggers the media content to be presented on the user device 504 via the output components 526 (e.g., speaker, display screen).

The media-streaming application 522 can include a stream-preprocessing module 528, a machine-learning classifier 530, a media-source selector 532, and a timer 534, which can be used individually or in combination to predict interruptions in various media content. For example, the stream-preprocessing module 528 can access initial media stream being presented by the user device 504. The media stream can include data being transmitted by the media source 514 to the user device 504 across a time period. The initial media stream can include media content 510 (e.g., video, audio). As an illustrative example, the media-streaming application 522 can be installed in the user device, in which the media-streaming application 522 provides an interface that facilitates streaming of music broadcasted by a classical music radio station in New York. The media-streaming application 522 can access the initial media stream as the music is being broadcasted from the media source 514 to the user device 504.

As described above, the initial media stream can additionally include other types of data. For example, the initial media stream can include metadata for use in identifying the media content 510 and/or the media source 514. Examples of metadata may include, but are not limited to, a genre, a song, an artist, an album, a media presentation (e.g., a concert, television show, movie, etc.), an identification of historical media streams (e.g., within a predetermined time interval such as past day, year, etc. or with any time interval), a media source (e.g., radio station), a location (e.g., a country, a state, a region, a city, an address, etc., a context (e.g., such as a concept, emotion, an experience, and/or the like), or the like.

The stream-preprocessing module 528 can identify the initial media content 510 (e.g., music, video) from the initial media stream. The initial media content 510 can include music content. In some instances, the media-streaming application identifies an initial topic or genre (e.g., classical music, Beethoven music) of the media content 510. The media-streaming application can identify the initial media content and its corresponding genre based on the metadata of the initial media stream. For example, the media-streaming application can parse the metadata of the initial media stream to determine that the classical music radio station is playing “Moonlight Sonata.” Based on the metadata, the media-streaming application can identify the classical-music content from the initial media stream. The identification of the initial media content can be performed in real-time as the content of the initial media stream continues to be presented on the user device.

In some instances, the stream-preprocessing module 528 can process the initial media stream such that the machine-learning classifier 530 can identify the media content 510. In some instances, the stream-processing module 528 modifies a sampling rate of the initial media stream to match the sample rate of the training data used to train a machine-learning model. For example, the stream-preprocessing module 528 can define a set of media segments (e.g., 1-second media segments) for a first time window of the initial media stream. The length of the media segment can be, but are not limited to, 10 ms, 50 ms, 100 ms, 250 ms, 500 ms, 750 ms, 1 second, 5 second, and more than 5 seconds. For each media segment of the first time window, the machine-learning classifier 530 can apply a machine-learning model to the media segment to generate a classification that indicates whether the given media segment corresponds to the initial media content (e.g., the media content 510). The media segment can be encoded into an n-dimensional feature representation before the media segment is processed by the machine-learning model. If the machine-learning model outputs consecutive classifications that the segments correspond to the initial media content (e.g., five or more consecutive classifications), the machine-learning classifier 530 can determine that the initial media stream includes the initial media content for the first time window. In some instances, the machine-learning classifier 530 additionally identifies an initial topic or genre by using the metadata from the initial media stream and/or by applying the machine-learning model.

Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods.

In some instances, the machine-learning model was trained using training data received and/or derived from media streams previously presented by the user device. Each data item of the training data can be labeled as either corresponding to media content or as non-media content. In some instances, the machine-learning model was trained using media streams associated other user devices (e.g., such as other devices executing the media-streaming application). Additionally or alternatively, the machine-learning model can be trained to predict a genre or topic associated with the media content, in which each data item of the training data can be labeled as corresponding to a particular genre or topic of the media content. The machine-learning model can be trained using supervised training, supervised training, semi-supervised training, reinforcement training, combinations thereof, or the like.

For example, the machine-learning model was trained using transfer learning. Transfer learning is a technique in machine learning where a machine-learning model initially trained to solve a particular task is used as the starting point for a different task. Transfer learning can be useful when the second task is somewhat similar to the first task, or when there is limited training data available for the second task. For example, a machine-learning model initially trained to recognize a topic from different paralinguistic speech signals can be further trained to predict an interruption in the initial media content. In some instances, the machine-learning classifier 530 accesses a pre-trained model and “fine-tunes” the pre-trained model by training it on a second training dataset. The second training dataset can include training data that are labeled as either corresponding to media content or as non-media content (e.g., an advertisement). To further fine-tune the machine-learning model, the machine-learning classifier 530 reconfigures the machine-learning model to include additional hidden and/or output layers to predict the interruption in the initial media content. In some instances, fine-tuning the pre-trained model includes unfreezing some of the layers of the pre-trained model and training them on the new training dataset. The number of layers that are unfrozen can depend on the size of the new dataset and how similar it is to the original dataset. For example, the fine-tuning of the machine-learning model can include freezing the weights of the machine-learning model, to train the machine-learning model to predict interruptions in the media content. Then, the weights can be unfrozen such that the machine-learning model can be trained to improve accuracy of the classification.

The machine-learning classifier 530 can also be configured to apply the machine-learning model to the initial media stream to dynamically predict in real-time an interruption of the media content 510. In particular, the interruption is predicted in real-time as media content 510 of the initial media stream continues to be presented on the user device 504. The predicted real-time interruption can include non-music content. For example, the non-music content can include an advertisement segment, a narration segment, a talk-show segment, and the like. In some instances, the predicted real-time interruption can include media content corresponding to a different genre or topic (e.g., news segment) from the initial genre or topic of the initial media content (e.g., classical music content). Additionally or alternatively, the predicted real-time interruption can include a network-connection loss from the media source 510.

For each media segment of a set of media segments for a second time window of the initial media stream, the machine-learning classifier 530 can apply the machine-learning model to the media segment to generate a classification that indicates whether the given media segment corresponds to the media content 510. The media segment can be encoded into an n-dimensional feature representation before the media segment is processed by the machine-learning model. If the machine-learning model outputs consecutive classifications that the media segments do not correspond to the initial media content, the machine-learning classifier 530 can determine that the media content 510 had been interrupted for the second time window. The consecutive classifications can reduce data noise and potential false positives, which in turn increases accuracy and consistency of predicting interruptions in the media content. The determination of the interruption can be performed as the user device 504 continues to present the media content 510 of the initial media stream. In some instances, predicting the interruption includes applying a data-smoothing algorithm to two or more outputs generated by the machine-learning model. The data-smoothing algorithm can be used to remove any noise or outliers associated with the initial media stream, such that the media-content classifications can be improved.

In response to the real-time predicted interruption, the media-source selector 532 can dynamically present a different media stream associated with the media source 516. For example, once the interruption has been predicted, the media-source selector 532 can dynamically switch to the media content 512 being broadcasted by the media source 516. In some instances, the media sources 514 and 516 are grouped together by the media-source aggregator, such that the media-source selector 532 selects the media source 516 as the interruption is detected from the initial media content 510. The association between the media sources 514 and 516 can be predetermined by the content provider (e.g., prior to streaming the media content to the user device 504) based on historical data from users that utilize the media-streaming application. Additionally or alternatively, the media source 516 can be identified as being substantially similar to the data source 514 by analyzing the respective media-source metadata 518 which can identify a genre of music, a location of the media sources, and the like. The switching of media streams allows the media content to be presented before or as soon as the interruption occurs in the user device 504.

In some instances, the media-streaming application initiates the timer 534. When the timer 534 expires, the user device 504 can revert to presenting the initial media stream from the media source 514. The timer 534 allows the temporary presentation of the different media stream (i.e., different media content). Additionally or alternatively, the timer 534 can be deactivated by the user to allow the different media stream from the media source 516 to be presented without reverting back to the initial media stream of the initial media source 514. In some instances, time length for the timer is configured by the user prior to activation of the timer 534, in which the time length can include 1 second, 5 seconds, 10 seconds, 15 seconds, 20 seconds, 25 seconds, 30 seconds, 35 seconds, 40 seconds, 45 seconds, 50 seconds, 55 seconds, 1 minute, 2 minutes, 3 minutes, 4 minutes, 5 minutes, 10 minutes, and more than 10 minutes.

In some instances, the machine-learning classifier 530 applies the machine-learning model to the initial media stream from the media source 514 to dynamically predict in real-time a conclusion of the interruption. The conclusion of the interruption can include the media source 514 ending the interruption and rebroadcasting the media content 510. In some instances, the conclusion of the interruption includes the media source 514 broadcasting media content having a genre or topic (e.g., jazz music) that is substantially similar to the initial genre or topic of the media content 510 (e.g., classical music). The conclusion of the interruption is predicted by the machine-learning classifier 530 while the media content 512 continues to be presented by the user device 504. For example, for each media segment of a set of media segments for a third time window of the initial media stream, the machine-learning classifier 530 can apply the machine-learning model to the media segment to generate a classification that indicates whether the given media segment corresponds to the initial media content. The media segment can be encoded into an n-dimensional feature representation before the media segment is processed by the machine-learning model. If the machine-learning model outputs consecutive classifications that the media segments correspond to the initial media content, the machine-learning classifier 530 can determine the conclusion of the interruption for the third time window.

In some instances, the media-streaming application 522 can generate a notification to be presented on the user device upon conclusion of the interruption. The notification can include a selectable option for the user device 504 to stream the media content from the initial media source. In some instances, the media-streaming application 522 automatically reverts to presenting the initial media stream upon conclusion of the interruption, which can be performed without providing prompts to the user device 504.

### C. Machine-Learning Techniques for a Server System Predicting Interruptions in Media Content

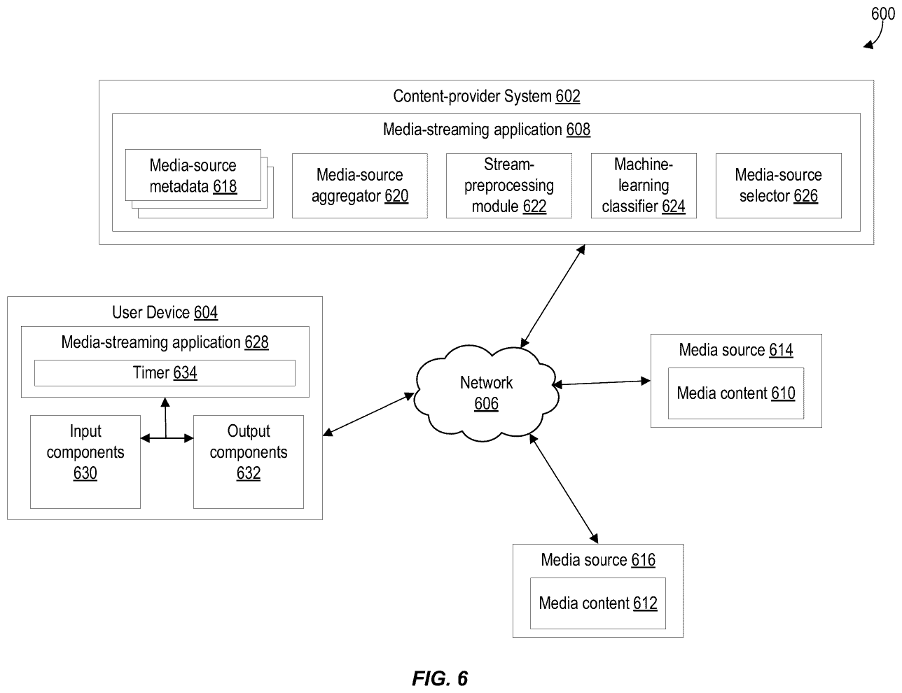

FIG. 6 illustrates an example computing environment 600 for a content-provider system predicting interruptions in media content using machine-learning techniques, according to some embodiments. In FIG. 6, a content-provider system 602 may include hardware and/or software components that operate within a distributed environment to stream media content to one or more user devices (e.g., a user device 604) over a communication network 606. The content-provider system 502 can store and execute a server-side media-streaming application 608, which may be configured to stream media content 610 and 612 broadcasted from various media sources (e.g., media sources 614 and 616). To facilitate streaming of media content, the server-side media-streaming application 608 can access various data from the user device 604 (e.g., a computing device, an in-vehicle entertainment system, a mobile device, or the like). For example, the media-streaming application 608 can access past browsing history of the user device 604 and user profile data of the user device 604 to identify a set of default media sources for streaming media content to the user device 604. In some instances, when operating in a distributed environment, the content-provider system 602 may include executable processes in which some processes may be executed by the user device 604 and some processes may be executed by the server 602.

The media-streaming application 608 may receive media streams corresponding to the media content 612 and 614 (e.g., such, but not limited to a radio broadcast) over the network 606 (e.g., a cloud network, a local area network, a wide area network, the Internet, etc.). The media streams may be transmitted or broadcasted by the media sources 614 and 616 (e.g., physical location from which a media stream is broadcasted or transmitted such as, but not limited to, a radio station). The media-streaming application 608 can process the media streams to present the corresponding media content to the user device 604. In some instances, the media streams are transmitted to the user device in a specific file format. For example, the media streams can be transmitted in audio file format, including but not limited to M4A, FLAC, MP3, MP4, WAV, WMA, and AAC file formats. In another example, the media streams can be transmitted in a video file format, including but not limited to MP4, MOV, AVI, WMV, AVCHD, WebM, and FLV.

The content-provider system 602 may include processing hardware (e.g., one or more processors such as CPU, memory, input components, output components, etc.) and a processor. The processor may include hardware components (e.g., media processor, other processors, memory, etc.) and/or software processes that execute to provide the functionality of the media-streaming application 608. The content-provider system 602 can also include one or more database that store media-source metadata 618 that include data for identifying media content broadcasted by a media source, a genre of the media content, a program schedule of content included in the media content, location of the media source, and/or the like.

In some instances, a media-source aggregator 620 stores groups of media sources that provide substantially similar media content. For example, the media-source aggregator 620 stores a first group of media sources that provide sports-news content, a second group of media sources that provide classical-rock content, and the like. As the user device 604 selects a particular music source provided by the media-streaming application 608, a corresponding group of media sources are presented together to allow the user to switch between different media sources to access similar media content. The association between the media sources can be predetermined by the content provider based on historical data from users that utilize the media-streaming application, locations at which the media sources are broadcasted, etc. In some instances, the media sources are grouped together by analyzing the respective metadata of the media streams.

In addition, the media-streaming application 608 of the content-provider system 602 can include a stream-preprocessing module 622, a machine-learning classifier 624, a media-source selector 626, which can be used individually or in combination to predict interruptions in various media content. For example, the stream-preprocessing module 622 can access initial media stream being presented by the user device 604. The media stream can include data being transmitted by the media source 614 to the user device 604 across a time period. The initial media stream can include media content 610 (e.g., video, audio). A media-streaming application 628 can be installed in the user device 604, in which the media-streaming application 628 provides an interface that facilitates streaming of the media content 610 broadcasted by the media source 614. The media-streaming application 608 can access the initial media stream as the music is being broadcasted from the media source 614 to the user device 604.

As described in FIGS. 4 and 5, the initial media stream can additionally include other types of data. For example, the initial media stream can include metadata for use in identifying the media content 610 and/or the media source 614. Examples of metadata may include, but are not limited to, a genre, a song, an artist, an album, a media presentation (e.g., a concert, television show, movie, etc.), an identification of historical media streams (e.g., within a predetermined time interval such as past day, year, etc. or with any time interval), a media source (e.g., radio station), a location (e.g., a country, a state, a region, a city, an address, etc., a context (e.g., such as a concept, emotion, an experience, and/or the like), or the like.

The stream-preprocessing module 622 can identify the initial media content 610 (e.g., music, video) from the initial media stream. The initial media content 610 can include music content. In some instances, the media-streaming application identifies an initial topic or genre (e.g., classical music, Beethoven music) of the media content 610. The media-streaming application can identify the initial media content and its corresponding genre based on the metadata of the initial media stream. For example, the media-streaming application can parse the metadata of the initial media stream to determine that the classical music radio station is playing “Moonlight Sonata.” Based on the metadata, the media-streaming application can identify the classical-music content from the initial media stream. The identification of the initial media content can be performed in real-time as the content of the initial media stream continues to be presented on the user device.

In some instances, the stream-preprocessing module 622 can process the initial media stream such that the machine-learning classifier 624 can identify the media content 610. In some instances, the stream-processing module 622 modifies a sampling rate of the initial media stream to match the sample rate of the training data used to train a machine-learning model. For example, the stream-preprocessing module 622 can define a set of media segments (e.g., 1-second media segments) for a first time window of the initial media stream. The length of the media segment can be, but are not limited to, 10 ms, 50 ms, 100 ms, 250 ms, 500 ms, 750 ms, 1 second, 5 second, and more than 5 seconds. For each media segment of the first time window, the machine-learning classifier 624 can apply a machine-learning model to the media segment to generate a classification that indicates whether the given media segment corresponds to the initial media content (e.g., the media content 610). The media segment can be encoded into an n-dimensional feature representation before the media segment is processed by the machine-learning model. If the machine-learning model outputs consecutive classifications that the segments correspond to the initial media content (e.g., five or more consecutive classifications), the machine-learning classifier 624 can determine that the initial media stream includes the initial media content for the first time window. In some instances, the machine-learning classifier 624 additionally identifies an initial topic or genre by using the metadata from the initial media stream and/or by applying the machine-learning model.

Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods.

In some instances, the machine-learning model was trained using training data received and/or derived from media streams previously presented by the user device. Each data item of the training data can be labeled as either corresponding to media content or as non-media content. In some instances, the machine-learning model was trained using media streams associated other user devices (e.g., such as other devices executing the media-streaming application). Additionally or alternatively, the machine-learning model can be trained to predict a genre or topic associated with the media content, in which each data item of the training data can be labeled as corresponding to a particular genre or topic of the media content. The machine-learning model can be trained using supervised training, supervised training, semi-supervised training, reinforcement training, combinations thereof, or the like.

For example, the machine-learning model was trained using transfer learning. Transfer learning is a technique in machine learning where a machine-learning model initially trained to solve a particular task is used as the starting point for a different task. Transfer learning can be useful when the second task is somewhat similar to the first task, or when there is limited training data available for the second task. For example, a machine-learning model initially trained to recognize a topic from different paralinguistic speech signals can be further trained to predict an interruption in the initial media content. In some instances, the machine-learning classifier 624 accesses a pre-trained model and “fine-tunes” the pre-trained model by training it on a second training dataset. The second training dataset can include training data that are labeled as either corresponding to media content or as non-media content (e.g., an advertisement). To further fine-tune the machine-learning model, the machine-learning classifier 624 reconfigures the machine-learning model to include additional hidden and/or output layers to predict the interruption in the initial media content. In some instances, fine-tuning the pre-trained model includes unfreezing some of the layers of the pre-trained model and training them on the new training dataset. The number of layers that are unfrozen can depend on the size of the new dataset and how similar it is to the original dataset. For example, the fine-tuning of the machine-learning model can include freezing the weights of the machine-learning model, to train the machine-learning model to predict interruptions in the media content. Then, the weights can be unfrozen such that the machine-learning model can be trained to improve accuracy of the classification.

The machine-learning classifier 624 can also be configured to apply the machine-learning model to the initial media stream to dynamically predict in real-time an interruption of the media content 610. In particular, the interruption is predicted in real-time as media content 610 of the initial media stream continues to be presented on the user device 604. The predicted real-time interruption can include non-music content. For example, the non-music content can include an advertisement segment, a narration segment, a talk-show segment, and the like. In some instances, the predicted real-time interruption can include media content corresponding to a different genre or topic (e.g., news segment) from the initial genre or topic of the initial media content (e.g., classical music content). Additionally or alternatively, the predicted real-time interruption can include a network-connection loss from the media source 610.

For each media segment of a set of media segments for a second time window of the initial media stream, the machine-learning classifier 624 can apply the machine-learning model to the media segment to generate a classification that indicates whether the given media segment corresponds to the media content 610. The media segment can be encoded into an n-dimensional feature representation before the media segment is processed by the machine-learning model. If the machine-learning model outputs consecutive classifications that the media segments do not correspond to the initial media content, the machine-learning classifier 624 can determine that the media content 610 had been interrupted for the second time window. The consecutive classifications can reduce data noise and potential false positives, which in turn increases accuracy and consistency of predicting interruptions in the media content. The determination of the interruption can be performed as the user device 604 continues to present the media content 610 of the initial media stream. In some instances, predicting the interruption includes applying a data-smoothing algorithm to two or more outputs generated by the machine-learning model. The data-smoothing algorithm can be used to remove any noise or outliers associated with the initial media stream, such that the media-content classifications can be improved.

In response to the real-time predicted interruption, the media-source selector 626 can dynamically present a different media stream associated with the media source 616. For example, once the interruption has been predicted, the media-source selector 626 can dynamically switch to the media content 612 being broadcasted by the media source 616. In some instances, the media sources 614 and 616 are grouped together by the media-source aggregator, such that the media-source selector 626 selects the media source 516 as the interruption is detected from the initial media content 610. The association between the media sources 616 and 616 can be predetermined by the content provider (e.g., prior to streaming the media content to the user device 604) based on historical data from users that utilize the media-streaming application. Additionally or alternatively, the media source 616 can be identified as being substantially similar to the data source 614 by analyzing the respective media-source metadata 618 which can identify a genre of music, a location of the media sources, and the like. The switching of media streams allows the media content to be presented before or as soon as the interruption occurs in the user device 604.

In some instances, the machine-learning classifier 624 applies the machine-learning model to the initial media stream from the media source 614 to dynamically predict in real-time a conclusion of the interruption. The conclusion of the interruption can include the media source 614 ending the interruption and rebroadcasting the media content 610. In some instances, the conclusion of the interruption includes the media source 614 broadcasting media content having a genre or topic (e.g., jazz music) that is substantially similar to the initial genre or topic of the media content 610 (e.g., classical music). The conclusion of the interruption is predicted by the machine-learning classifier 624 while the media content 612 continues to be presented by the user device 604. For example, for each media segment of a set of media segments for a third time window of the initial media stream, the machine-learning classifier 624 can apply the machine-learning model to the media segment to generate a classification that indicates whether the given media segment corresponds to the initial media content. The media segment can be encoded into an n-dimensional feature representation before the media segment is processed by the machine-learning model. If the machine-learning model outputs consecutive classifications that the media segments correspond to the initial media content, the machine-learning classifier 624 can determine the conclusion of the interruption for the third time window.

In some instances, the media-streaming application 608 can generate and transmit a notification to be presented on the user device 604 upon conclusion of the interruption. The notification can include a selectable option for the user device 604 to stream the media content from the initial media source. In some instances, the media-streaming application 608 automatically reverts to presenting the initial media stream upon conclusion of the interruption, which can be performed without providing prompts to the user device 604.

The user-device 604 can include processing hardware (e.g., one or more processors such as CPU, memory, input components, output components, etc.) and a processor. The processor may include hardware components (e.g., media processor, other processors, memory, etc.) and/or software processes that execute to receive the media stream from the content-provider system 602 and present the media stream to provide media content for a user. The user-device 602 also include a client-side media-streaming application 628, input components 630, and output components 623. The media-streaming application 628 can be receive media stream transmitted by the content-provider system 602 and present media content from various media sources. In some instances, the media-streaming application 628 presents different media content in response to the content-provider system 602 predicting in real-time an interruption to the initial media content being presented to the user device 604. In some instances, the media-streaming application 628 provides a timer 634. When the timer 634 expires, the user device 605 can transmit a request to the content-provider system to revert to presenting the initial media stream from the media source 614, regardless of whether the interruption has been concluded. The timer 634 allows the temporary presentation of the different media stream (i.e., different media content). Additionally or alternatively, the timer 634 can be deactivated by the user to allow the different media stream from the media source 616 to be presented without reverting back to the initial media stream of the initial media source 614. In some instances, the time length for the timer is configured by the user prior to activation of the timer 634, in which the time length can include 1 second, 5 seconds, 10 seconds, 15 seconds, 20 seconds, 25 seconds, 30 seconds, 35 seconds, 40 seconds, 45 seconds, 50 seconds, 55 seconds, 1 minute, 2 minutes, 3 minutes, 4 minutes, 5 minutes, 10 minutes, and more than 10 minutes.

To enable user interaction with the media-streaming application 628, the input components 630 can be utilized, which can include a microphone for speech, a touch-sensitive screen for gesture or graphical input, keyboard, mouse, motion input, pen, and other such input devices. In addition, the media content from the media source can be outputted using the output components 632, which can include, but not limited to, monitors, speakers, printers, haptic devices, and other such output devices. In some instances, the user device 604 interacts with the media-streaming application 622 through a user interface to identify media sources and access their respective media streams. The user interface may display one or more user interface elements that identify the media content presented, being presented, and/or to be presented by the user device (e.g., the media content 610), as well as the media source corresponding to the media content (e.g., the media source 614). The user input may be received using the input components 524 to select an icon that represents a media source, which triggers the media content to be presented on the user device 604 via the output components 626 (e.g., speaker, display screen).

### D. Machine-Learning Techniques for a Special-Purpose System Predicting Interruptions in Media Content

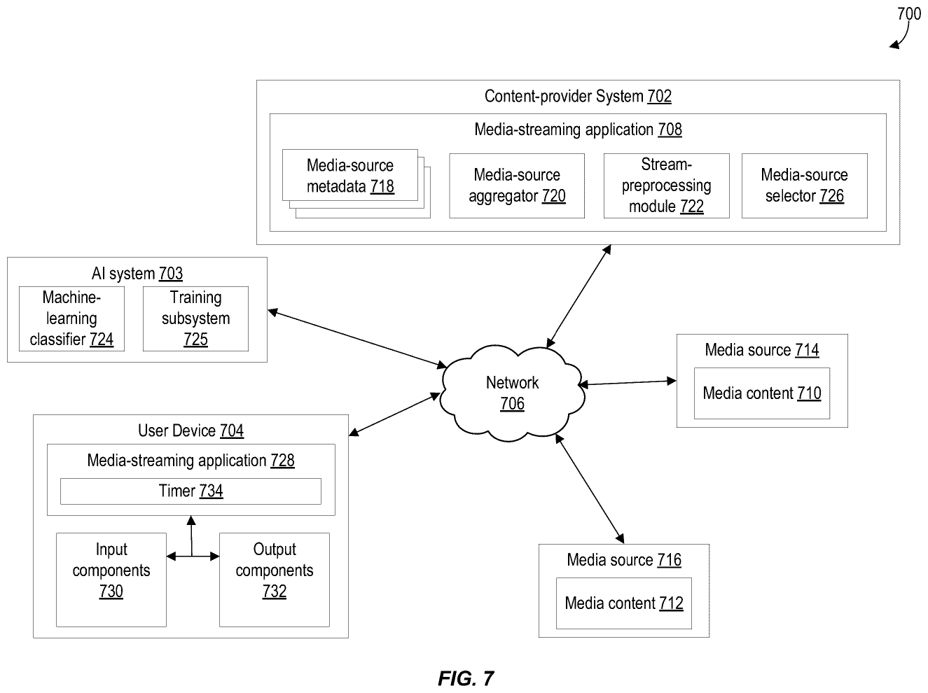

FIG. 7 illustrates an example computing environment 700 for a content-provider system predicting interruptions in media content based on output generated from a special-purpose computer, according to some embodiments. In FIG. 7, a content-provider system 702 may include hardware and/or software components that operate within a distributed environment to stream media content to one or more user devices (e.g., a user device 704) over a communication network 706. The content-provider system 502 can store and execute a server-side media-streaming application 708, which may be configured to stream media content 710 and 712 broadcasted from various media sources (e.g., media sources 714 and 716). To facilitate streaming of media content, the server-side media-streaming application 708 can access various data from the user device 704 (e.g., a computing device, an in-vehicle entertainment system, a mobile device, or the like). For example, the media-streaming application 708 can access past browsing history of the user device 704 and user profile data of the user device 704 to identify a set of default media sources for streaming media content to the user device 704. In some instances, when operating in a distributed environment, the content-provider system 702 may include executable processes in which some processes may be executed by the user device 704 and some processes may be executed by the server 702.

The media-streaming application 708 may receive media streams corresponding to the media content 712 and 714 (e.g., such, but not limited to a radio broadcast) over the network 706 (e.g., a cloud network, a local area network, a wide area network, the Internet, etc.). The media streams may be transmitted or broadcasted by the media sources 714 and 716 (e.g., physical location from which a media stream is broadcasted or transmitted such as, but not limited to, a radio station). The media-streaming application 708 can process the media streams to present the corresponding media content to the user device 704. In some instances, the media streams are transmitted to the user device in a specific file format. For example, the media streams can be transmitted in audio file format, including but not limited to M4A, FLAC, MP3, MP4, WAV, WMA, and AAC file formats. In another example, the media streams can be transmitted in a video file format, including but not limited to MP4, MOV, AVI, WMV, AVCHD, WebM, and FLV.

The content-provider system 702 may include processing hardware (e.g., one or more processors such as CPU, memory, input components, output components, etc.) and a processor. The processor may include hardware components (e.g., media processor, other processors, memory, etc.) and/or software processes that execute to provide the functionality of the media-streaming application 708. The content-provider system 702 can also include one or more database that store media-source metadata 718 that include data for identifying media content broadcasted by a media source, a genre of the media content, a program schedule of content included in the media content, location of the media source, and/or the like.

In some instances, a media-source aggregator 720 stores groups of media sources that provide substantially similar media content. For example, the media-source aggregator 720 stores a first group of media sources that provide sports-news content, a second group of media sources that provide classical-rock content, and the like. As the user device 704 selects a particular music source provided by the media-streaming application 708, a corresponding group of media sources are presented together to allow the user to switch between different media sources to access similar media content. The association between the media sources can be predetermined by the content provider based on historical data from users that utilize the media-streaming application, locations at which the media sources are broadcasted, etc. In some instances, the media sources are grouped together by analyzing the respective metadata of the media streams.

In addition, the media-streaming application 708 of the content-provider system 702 can include a stream-preprocessing module 722 and a media-source selector 726, which can be used individually or in combination to predict interruptions in various media content. For example, the stream-preprocessing module 722 can access initial media stream being presented by the user device 704. The media stream can include data being transmitted by the media source 714 to the user device 704 across a time period. The initial media stream can include media content 710 (e.g., video, audio). A media-streaming application 728 can be installed in the user device 704, in which the media-streaming application 728 provides an interface that facilitates streaming of the media content 710 broadcasted by the media source 714. The media-streaming application 708 can access the initial media stream as the music is being broadcasted from the media source 714 to the user device 704.

As described in FIGS. 4 and 5, the initial media stream can additionally include other types of data. For example, the initial media stream can include metadata for use in identifying the media content 710 and/or the media source 714. Examples of metadata may include, but are not limited to, a genre, a song, an artist, an album, a media presentation (e.g., a concert, television show, movie, etc.), an identification of historical media streams (e.g., within a predetermined time interval such as past day, year, etc. or with any time interval), a media source (e.g., radio station), a location (e.g., a country, a state, a region, a city, an address, etc., a context (e.g., such as a concept, emotion, an experience, and/or the like), or the like.

The stream-preprocessing module 722 can identify the initial media content 710 (e.g., music, video) from the initial media stream. The initial media content 710 can include music content. In some instances, the media-streaming application identifies an initial topic or genre (e.g., classical music, Beethoven music) of the media content 710. The media-streaming application can identify the initial media content and its corresponding genre based on the metadata of the initial media stream. For example, the media-streaming application can parse the metadata of the initial media stream to determine that the classical music radio station is playing “Moonlight Sonata.” Based on the metadata, the media-streaming application can identify the classical-music content from the initial media stream. The identification of the initial media content can be performed in real-time as the content of the initial media stream continues to be presented on the user device.

In some instances, the stream-preprocessing module 722 can interact with the AI system 703 to identify the media content 710. In some embodiments, the AI system 703 is implemented by a special purpose computer that is specifically configured to process the media stream broadcasted by a media source (e.g., the media source 714) and predict in real-time any interruptions of the media content 710 being presented on the user device 704. Additionally, one or more components of the AI system 703 is implemented by another special purpose computer (e.g., a training subsystem 725) that is specifically configured to train the machine-learning model using an amount of historical data and applying the trained machine-learning algorithms to predict in real-time any interruptions of the media content 710 being presented on the user device 704.

In some instances, the stream-processing module 722 modifies a sampling rate of the initial media stream to match the sample rate of the training data used to train a machine-learning model. For example, the stream-preprocessing module 722 can define a set of media segments (e.g., 1-second media segments) for a first time window of the initial media stream. The length of the media segment can be, but are not limited to, 10 ms, 50 ms, 100 ms, 250 ms, 500 ms, 750 ms, 1 second, 5 second, and more than 5 seconds. The stream-preprocessing module 722 can transmit the set of media segments to the AI system 703. Once the AI system 703 receives the set of media segments, a machine-learning classifier 724 of the AI system 703 can apply a machine-learning model to the set of media segments to generate a classification that indicates whether the set of media segments correspond to the initial media content (e.g., the media content 710). The media segment can be encoded into an n-dimensional feature representation before the media segment is processed by the machine-learning model. If the machine-learning model outputs consecutive classifications that the segments correspond to the initial media content (e.g., five or more consecutive classifications) for the media segments, the machine-learning classifier 724 can determine that the initial media stream includes the initial media content for the first time window. Based on the determination, the AI system 703 can transmit an output to the content-provider system 702, in which the output indicates that the initial media stream includes the media content 710. In some instances, the machine-learning classifier 724 additionally identifies an initial topic or genre by using the metadata from the initial media stream and/or by applying the machine-learning model. After identifying the initial topic or genre, the AI system 703 can transmit the identified topic or genre to the content-provider system 702 for further processing.

Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods.

The training subsystem 725 of the AI system can be configured to train the machine-learning model using training data received and/or derived from media streams previously presented by the user device 704. Each data item of the training data can be labeled as either corresponding to media content or as non-media content. In some instances, the training subsystem 725 trains the machine-learning model using media streams associated other user devices (e.g., such as other devices executing the media-streaming application). Additionally or alternatively, the training subsystem 725 can train the machine-learning model to predict a genre or topic associated with the media content, in which each data item of the training data can be labeled as corresponding to a particular genre or topic of the media content. The training subsystem 725 can train the machine-learning model using supervised training, supervised training, semi-supervised training, reinforcement training, combinations thereof, or the like.

For example, the training subsystem 725 can train the machine-learning model using transfer learning. Transfer learning is a technique in machine learning where a machine-learning model initially trained by the training subsystem 725 to solve a particular task is used as the starting point for a different task. Transfer learning can be useful when the second task is somewhat similar to the first task, or when there is limited training data available for the second task. For example, a machine-learning model initially trained to recognize a topic from different paralinguistic speech signals can be further trained to predict an interruption in the initial media content. In some instances, the training subsystem 725 accesses a pre-trained model and “fine-tunes” the pre-trained model by training it on a second training dataset. The second training dataset can include training data that are labeled as either corresponding to media content or as non-media content (e.g., an advertisement). To further fine-tune the machine-learning model, the training subsystem 725 reconfigures the machine-learning model to include additional hidden and/or output layers to predict the interruption in the initial media content. In some instances, fine-tuning the pre-trained model includes unfreezing some of the layers of the pre-trained model and training them on the new training dataset. The number of layers that are unfrozen can depend on the size of the new dataset and how similar it is to the original dataset. For example, the training subsystem 725 can fine-tune the machine-learning model by freezing the weights of the machine-learning model, to train the machine-learning model to predict interruptions in the media content. Then, the training subsystem 725 can unfreeze the weights such that the machine-learning model can be further trained to improve accuracy of the classification.

The machine-learning classifier 724 of the AI system 703 can also be configured to apply the machine-learning model to the initial media stream to dynamically predict in real-time an interruption of the media content 710. The interruption can be predicted in real-time as media content 710 of the initial media stream continues to be presented on the user device 704. For example, as the user device 704 continues to present the media content 710, the machine-learning classifier 724 processes the initial media stream to predict in real-time whether an interruption has occurred in the media content 710. The predicted real-time interruption can include non-music content. For example, the non-music content can include an advertisement segment, a narration segment, a talk-show segment, and the like. In some instances, the predicted real-time interruption can include media content corresponding to a different genre or topic (e.g., news segment) from the initial genre or topic of the initial media content (e.g., classical music content). Additionally or alternatively, the predicted real-time interruption can include a network-connection loss from the media source 710.

For each media segment of a set of media segments for a second time window of the initial media stream, the machine-learning classifier 724 can apply the machine-learning model to the media segment to generate a classification that indicates whether the given media segment corresponds to the media content 710. The media segment can be encoded into an n-dimensional feature representation before the media segment is processed by the machine-learning model. If the machine-learning model outputs consecutive classifications that the media segments do not correspond to the initial media content, the machine-learning classifier 724 can determine that the media content 710 had been interrupted for the second time window. The consecutive classifications can reduce data noise and potential false positives, which in turn increases accuracy and consistency of predicting interruptions in the media content. The determination of the interruption can be performed as the user device 704 continues to present the media content 710 of the initial media stream. In some instances, predicting the interruption includes applying a data-smoothing algorithm to two or more outputs generated by the machine-learning model. The data-smoothing algorithm can be used to remove any noise or outliers associated with the initial media stream, such that the media-content classifications can be improved.

Based on the determination, the AI system 703 can transmit an output to the content-provider system 702, in which the output indicates the predicted interruption of the media content 710. In response to the real-time predicted interruption, the media-source selector 726 of the content-provider system 702 can dynamically present a different media stream associated with the media source 716. For example, once the interruption has been predicted, the media-source selector 726 can dynamically switch to the media content 712 being broadcasted by the media source 716. In some instances, the media sources 714 and 716 are grouped together by the media-source aggregator, such that the media-source selector 726 selects the media source 516 as the interruption is detected from the initial media content 710. The association between the media sources 716 and 716 can be predetermined by the content provider (e.g., prior to streaming the media content to the user device 704) based on historical data from users that utilize the media-streaming application. Additionally or alternatively, the media source 716 can be identified as being substantially similar to the data source 714 by analyzing the respective media-source metadata 718 which can identify a genre of music, a location of the media sources, and the like. The switching of media streams allows the media content to be presented before or as soon as the interruption occurs in the user device 704.

In some instances, the machine-learning classifier 724 of the AI system 703 continues to apply the machine-learning model to the initial media stream from the media source 714 to dynamically predict in real-time a conclusion of the interruption. The conclusion of the interruption can include the media source 714 ending the interruption and rebroadcasting the media content 710. In some instances, the conclusion of the interruption includes the media source 714 broadcasting media content having a genre or topic (e.g., jazz music) that is substantially similar to the initial genre or topic of the media content 710 (e.g., classical music). The conclusion of the interruption is predicted by the machine-learning classifier 724 while the media content 712 continues to be presented by the user device 704. For example, for each media segment of a set of media segments for a third time window of the initial media stream, the machine-learning classifier 724 of the AI system 703 can apply the machine-learning model to the media segment to generate a classification that indicates whether the given media segment corresponds to the initial media content. The media segment can be encoded into an n-dimensional feature representation before the media segment is processed by the machine-learning model. If the machine-learning model outputs consecutive classifications that the media segments correspond to the initial media content, the machine-learning classifier 724 can determine the conclusion of the interruption for the third time window. Based on the determination, the AI system 703 can transmit another output to the content-provider system 702, in which the output indicates that the interruption of the media content 710 has been concluded.

In some instances, the media-streaming application 708 can generate and transmit a notification to be presented on the user device 704 upon conclusion of the interruption. The notification can include a selectable option for the user device 704 to stream the media content from the initial media source. In some instances, the media-streaming application 708 automatically reverts to presenting the initial media stream upon conclusion of the interruption, which can be performed without providing prompts to the user device 704.

The user-device 704 can include processing hardware (e.g., one or more processors such as CPU, memory, input components, output components, etc.) and a processor. The processor may include hardware components (e.g., media processor, other processors, memory, etc.) and/or software processes that execute to receive the media stream from the content-provider system 702 and present the media stream to provide media content for a user. The user-device 702 also include a client-side media-streaming application 728, input components 730, and output components 723. The media-streaming application 728 can be receive media stream transmitted by the content-provider system 702 and present media content from various media sources. In some instances, the media-streaming application 728 presents different media content in response to the content-provider system 702 predicting in real-time an interruption to the initial media content being presented to the user device 704. In some instances, the media-streaming application 728 provides a timer 734. When the timer 734 expires, the user device 705 can transmit a request to the content-provider system to revert to presenting the initial media stream from the media source 714, regardless of whether the interruption has been concluded. The timer 734 allows the temporary presentation of the different media stream (i.e., different media content). Additionally or alternatively, the timer 734 can be deactivated by the user to allow the different media stream from the media source 716 to be presented without reverting back to the initial media stream of the initial media source 714. In some instances, time length for the timer is configured by the user prior to activation of the timer 734, in which the time length can include 1 second, 5 seconds, 10 seconds, 15 seconds, 20 seconds, 25 seconds, 30 seconds, 35 seconds, 40 seconds, 45 seconds, 50 seconds, 55 seconds, 1 minute, 2 minutes, 3 minutes, 4 minutes, 5 minutes, 10 minutes, and more than 10 minutes.

To enable user interaction with the media-streaming application 728, the input components 730 can be utilized, which can include a microphone for speech, a touch-sensitive screen for gesture or graphical input, keyboard, mouse, motion input, pen, and other such input devices. In addition, the media content from the media source can be outputted using the output components 732, which can include, but not limited to, monitors, speakers, printers, haptic devices, and other such output devices. In some instances, the user device 704 interacts with the media-streaming application 722 through a user interface to identify media sources and access their respective media streams. The user interface may display one or more user interface elements that identify the media content presented, being presented, and/or to be presented by the user device (e.g., the media content 710), as well as the media source corresponding to the media content (e.g., the media source 714). The user input may be received using the input components 524 to select an icon that represents a media source, which triggers the media content to be presented on the user device 704 via the output components 726 (e.g., speaker, display screen).

### E. Methods for Predicting Interruptions in Media Content

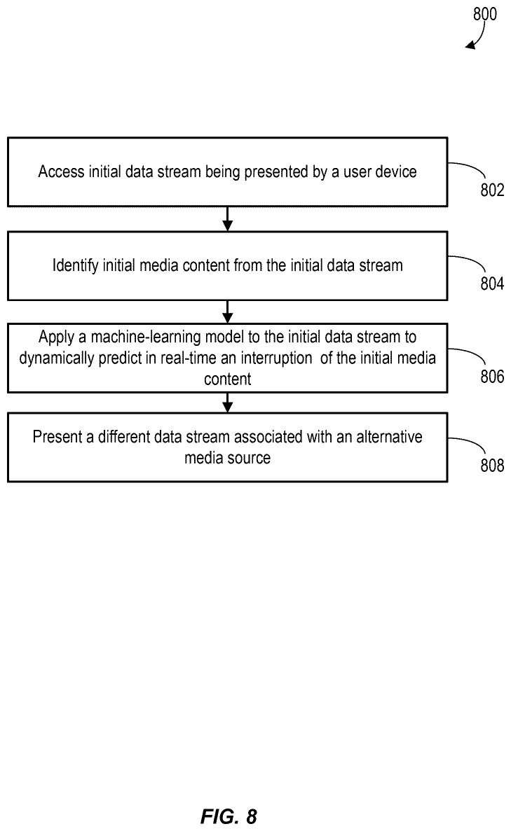

FIG. 8 illustrates an example process 800 for predicting interruptions in media content using machine-learning techniques, according to some embodiments. For illustrative purposes, the process 800 is described with reference to the components illustrated in FIGS. 4-7, though other implementations are possible. For example, the program code for the media-streaming application of FIGS. 4-7, is executed by one or more processing devices to cause a server system (e.g., the computing device 902 of FIG. 9) to perform one or more operations described herein.

At step 802, a media-streaming application (e.g., the media-streaming application 502 of FIG. 5) can access initial media stream being presented by a user device. The media stream can include data being transmitted by a media source (e.g., a radio station) to the user device across a time period. The initial media stream can include media content (e.g., video, audio) and can be associated with an initial media source. As an illustrative example, the media-streaming application can be installed in the user device, in which the media-streaming application provides an interface that facilitates streaming of music broadcasted by a classical music radio station in New York. In another example, the user device can launch an internet browser to access a website of a content provider that stores the media-streaming application. A user can then interact with one or more interface elements of the website to stream the music broadcasted from the New York classical music radio station. In both examples, the media-streaming application can access the initial media stream as the music is being broadcasted from the initial media source (e.g., the New York classical music radio station) to the user device.

In addition to media content, the initial media stream can additionally include other types of data. For example, the initial media stream can include metadata for use in identifying the media content and/or media sources broadcasting the media content. Examples of metadata may include, but are not limited to, a genre, a song, an artist, an album, a media presentation (e.g., a concert, television show, movie, etc.), an identification of historical media streams (e.g., within a predetermined time interval such as past day, year, etc. or with any time interval), a media source (e.g., radio station), a location (e.g., a country, a state, a region, a city, an address, etc., a context (e.g., such as a concept, emotion, an experience, and/or the like), or the like.

At step 804, the media-streaming application can identify initial media content (e.g., music, video) from the initial media stream. The initial media content can include music content. In some instances, the media-streaming application identifies an initial topic or genre (e.g., classical music, Beethoven music) of the initial media content. The media-streaming application can identify the initial media content based on the metadata of the initial media stream. Continuing with the example, the media-streaming application can parse the metadata of the initial media stream to determine that the classical music radio station is playing “Moonlight Sonata.” Based on the metadata, the media-streaming application can identify the classical-music content from the initial media stream. The identification of the initial media content can be performed in real-time as the content of the initial media stream continues to be presented on the user device.

In some instances, the media-streaming application identifies the initial media content by using machine-learning techniques. For example, the media-streaming application can define a set of media segments (e.g., 1-second media segments) for a first time window of the initial media stream. For each media segment of the first time window, the media-streaming application can apply a machine-learning model to the media segment to generate a classification that indicates whether the given media segment corresponds to the initial media content. If the machine-learning model outputs consecutive classifications that the segments correspond to the initial media content (e.g., five or more consecutive classifications), the media-streaming application can determine that the initial media stream includes the initial media content for the first time window. In some instances, the media-streaming application additionally identifies an initial topic or genre by using the metadata from the initial media stream and/or by applying the machine-learning model.

In some instances, the machine-learning model was trained using training data received and/or derived from media streams previously presented by the user device. Each data item of the training data can be labeled as either corresponding to media content or as non-media content. In some instances, the machine-learning model was trained using media streams associated other user devices (e.g., such as other devices executing the media-streaming application). Additionally or alternatively, the machine-learning model can be trained to predict a genre or topic associated with the media content, in which each data item of the training data can be labeled as corresponding to a particular genre or topic of the media content. The machine-learning model can be trained using supervised training, supervised training, semi-supervised training, reinforcement training, combinations thereof, or the like. For example, the machine-learning model was trained using transfer learning.

At step 806, the media-streaming application can apply the machine-learning model to the initial media stream to dynamically predict in real-time an interruption of the initial media content. In particular, the interruption is predicted in real-time as media content of the initial media stream continues to be presented on the user device. Continuing with the example, the media-streaming application can apply the machine-learning model to the initial media stream to predict that: (i) the song “Moonlight Sonata” has ended; and (ii) the broadcast is now streaming an advertisement. The predicted real-time interruption can include non-music content. For example, the non-music content can include an advertisement segment, a narration segment, a talk-show segment, and the like. In some instances, the predicted real-time interruption can include media content corresponding to a different genre or topic (e.g., news segment) from the initial genre or topic of the initial media content (e.g., classical music content). Additionally or alternatively, the predicted real-time interruption can include a network-connection loss from the initial media source.

As noted above, the interruption can be predicted using machine-learning techniques. For each media segment of a set of media segments for a second time window of the initial media stream, the media-streaming application can apply the machine-learning model to the media segment to generate a classification that indicates whether the given media segment corresponds to the initial media content. If the machine-learning model outputs consecutive classifications that the media segments do not correspond to the initial media content, the media-streaming application can determine that the initial media content had been interrupted for the second time window. The determination of the interruption can be performed as the user device continues to present the media content of the initial media stream. In some instances, predicting the interruption includes applying a data-smoothing algorithm to two or more outputs generated by the machine-learning model. The data-smoothing algorithm can be used to remove any noise or outliers associated with the initial media stream, such that the media-content classifications can be improved.

At step 808, the media-streaming application can dynamically present a different media stream associated with an alternative media source in response to the real-time predicted interruption. For example, once the interruption has been predicted, the media-streaming application can dynamically switch to the media stream being broadcasted by a classical music radio station in San Francisco. The different media stream can include its media content (e.g., “Fur Elise” composed by Ludwig van Beethoven) that may be substantially similar with the initial media content. The switching of media streams allows the media content to be presented before or as soon as the interruption occurs in the user device. In some instances, the media-streaming application initiates a timer. When the timer expires, the user device can revert to presenting the initial media stream. The timer allows the temporary presentation of the different media stream (i.e., different media content). Additionally or alternatively, the timer can be deactivated by the user to allow the different media stream to be presented without reverting back to the initial media stream.

In some instances, the alternative media source is associated with media content that substantially matches the initial media content of the initial media source. For example, the media content from the alternative media source may also include classical music (e.g., Pachebel's Canon), which can be similar with the “Moonlight Sonata” that was initially streamed on the user device. The association between the initial media source and the alternative media source can be predetermined by the content provider based on historical data from users that utilize the media-streaming application. Additionally or alternatively, the alternative media source can be identified as being substantially similar to the initial data source by analyzing the respective metadata of the media streams. For example, the metadata from the different media stream can indicate that the alternative media source is another classical music radio stations based on San Francisco, which is substantially similar with the classical music radio station in New York.

In some instances, the media-streaming application applies the machine-learning model to the initial media stream to dynamically predict in real-time a conclusion of the interruption. The conclusion of the interruption can include the initial media source ending the interruption and rebroadcasting the initial media content. In some instances, the conclusion of the interruption includes the initial media source broadcasting media content having a genre or topic (e.g., jazz music) that is substantially similar to the initial genre or topic of the initial media content (e.g., classical music). The conclusion of the interruption is predicted while the different media stream continues to be presented by the user device. For example, for each media segment of a set of media segments for a third time window of the initial media stream, the media-streaming application can apply the machine-learning model to the media segment to generate a classification that indicates whether the given media segment corresponds to the initial media content. If the machine-learning model outputs consecutive classifications that the media segments correspond to the initial media content, the media-streaming application can determine the conclusion of the interruption for the third time window.

The media-streaming application can generate a notification to be presented on the user device upon conclusion of the interruption. The notification can include a selectable option for the user device to stream the media content from the initial media source. For example, once the advertisement ends for the New York radio station, the media-streaming application can generate a notification that prompts whether the user is interested in returning to the media content broadcasted New York radio station. The user can either respond to the notification by returning to the New York radio station or permanently switching to the San Francisco radio station. In some instances, the media-streaming application automatically reverts to presenting the initial media stream upon conclusion of the interruption, which can be performed without providing prompts to the user device. Process 800 terminates thereafter.

### III. Systems for Temporarily Replacing Media Content and Predicting Interruptions in Media Content

FIG. 9 illustrates a computing system architecture 900, including various components in electrical communication with each other, in accordance with some embodiments. The example computing system architecture 900 illustrated in FIG. 9 includes a computing device 902, which has various components in electrical communication with each other using a connection 906, such as a bus, in accordance with some implementations. The example computing system architecture 900 includes a processing unit 904 that is in electrical communication with various system components, using the connection 906, and including the system memory 914. In some embodiments, the system memory 914 includes read-only memory (ROM), random-access memory (RAM), and other such memory technologies including, but not limited to, those described herein. In some embodiments, the example computing system architecture 900 includes a cache 908 of high-speed memory connected directly with, in close proximity to, or integrated as part of the processor 904. The system architecture 900 can copy data from the memory 914 and/or the storage device 910 to the cache 908 for quick access by the processor 904. In this way, the cache 908 can provide a performance boost that decreases or eliminates processor delays in the processor 904 due to waiting for data. Using modules, methods and services such as those described herein, the processor 904 can be configured to perform various actions. In some embodiments, the cache 908 may include multiple types of cache including, for example, level one (L1) and level two (L2) cache. The memory 914 may be referred to herein as system memory or computer system memory. The memory 914 may include, at various times, elements of an operating system, one or more applications, data associated with the operating system or the one or more applications, or other such data associated with the computing device 902.

Other system memory 914 can be available for use as well. The memory 914 can include multiple different types of memory with different performance characteristics. The processor 904 can include any general purpose processor and one or more hardware or software services, such as service 912 stored in storage device 910, configured to control the processor 904 as well as a special-purpose processor where software instructions are incorporated into the actual processor design. The processor 904 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 904 can be a microprocessor, a microcontroller, a digital signal processor (“DSP”), or a combination of these and/or other types of processors. In some embodiments, the processor 904 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 900, an input device 916 can represent any number of input mechanisms, such as a microphone for speech, a touch-sensitive screen for gesture or graphical input, keyboard, mouse, motion input, pen, and other such input devices. An output device 918 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 900. In some embodiments, the input device 916 and/or the output device 918 can be coupled to the computing device 902 using a remote connection device such as, for example, a communication interface such as the network interface 920 described herein. In such embodiments, the communication interface can govern and manage the input and output received from the attached input device 916 and/or output device 918. As may be contemplated, there is no restriction on operating on any particular hardware arrangement and accordingly the basic features here may easily be substituted for other hardware, software, or firmware arrangements as they are developed.

In some embodiments, the storage device 910 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 910 can include hardware and/or software services such as service 912 that can control or configure the processor 904 to perform one or more functions including, but not limited to, the methods, processes, functions, systems, and services described herein in various embodiments. In some embodiments, the hardware or software services can be implemented as modules. As illustrated in example computing system architecture 900, the storage device 910 can be connected to other parts of the computing device 902 using the system connection 906. In some embodiments, a hardware service or hardware module such as service 912, that performs a function can include a software component stored in a non-transitory computer-readable medium that, in connection with the necessary hardware components, such as the processor 904, connection 906, cache 908, storage device 910, memory 914, input device 916, output device 918, and so forth, can carry out the functions such as those described herein.

The disclosed systems and service of a media-streaming application (e.g., the media-streaming application 522 described herein at least in connection with FIG. 5) can be performed using a computing system such as the example computing system illustrated in FIG. 9, using one or more components of the example computing system architecture 900. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for generating proposals associated with a media-streaming application (e.g., the media-streaming application 522 described herein at least in connection with FIG. 5) described herein by, for example, executing code using a processor such as processor 904 wherein the code is stored in memory such as memory 914 as described herein. One or more of a user device, a provider server or system, a database system, or other such devices, services, or systems may include some or all of the components of the computing system such as the example computing system illustrated in FIG. 9, using one or more components of the example computing system architecture 900 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 928. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 904 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 914 can be coupled to the processor 904 by, for example, a connector such as connector 906, or a bus. As used herein, a connector or bus such as connector 906 is a communications system that transfers data between components within the computing device 902 and may, in some embodiments, be used to transfer data between computing devices. The connector 906 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 914 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 914 can also include magnetic or optical data storage media including read-only (e.g., CD ROM and DVD ROM) or otherwise (e.g., CD or DVD). The memory can be local, remote, or distributed.

As described above, the connector 906 (or bus) can also couple the processor 904 to the storage device 910, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 910. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 906 can also couple the processor 904 to a network interface device such as the network interface 920. The interface can include one or more of a modem or other such network interfaces including, but not limited to those described herein. It will be appreciated that the network interface 920 may be considered to be part of the computing device 902 or may be separate from the computing device 902. The network interface 920 can include one or more of an analog modem, Integrated Services Digital Network (ISDN) modem, cable modem, token ring interface, satellite transmission interface, or other interfaces for coupling a computer system to other computer systems. In some embodiments, the network interface 920 can include one or more input and/or output (I/O) devices. The I/O devices can include, by way of example but not limitation, input devices such as input device 916 and/or output devices such as output device 918. For example, the network interface 920 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunGS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 902 can be connected to one or more additional computing devices such as computing device 924 via a network 922 using a connection such as the network interface 920. In such embodiments, the computing device 924 may execute one or more services 926 to perform one or more functions under the control of, or on behalf of, programs and/or services operating on computing device 902. In some embodiments, a computing device such as computing device 924 may include one or more of the types of components as described in connection with computing device 902 including, but not limited to, a processor such as processor 904, a connection such as connection 906, a cache such as cache 908, a storage device such as storage device 910, memory such as memory 914, an input device such as input device 916, and an output device such as output device 918. In such embodiments, the computing device 924 can carry out the functions such as those described herein in connection with computing device 902. In some embodiments, the computing device 902 can be connected to a plurality of computing devices such as computing device 924, each of which may also be connected to a plurality of computing devices such as computing device 924. Such an embodiment may be referred to herein as a distributed computing environment.

The network 922 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 922 can be wired connections, wireless connections, or combinations thereof. Communications via the network 922 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 922, within the computing device 902, within the computing device 924, or within the computing resources provider 928 can include information, which also may be referred to herein as content. The information may include text, graphics, audio, video, haptics, and/or any other information that can be provided to a user of the computing device such as the computing device 902. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 902 and presented to a user of the computing device 902 using forms that are perceptible via sight, sound, smell, taste, touch, or other such mechanisms. In some embodiments, communications over the network 922 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 902 and/or the computing device 924 can be connected to a computing resources provider 928 via the network 922 using a network interface such as those described herein (e.g. network interface 920). In such embodiments, one or more systems (e.g., service 930 and service 932) hosted within the computing resources provider 928 (also referred to herein as within “a computing resources provider environment”) may execute one or more services to perform one or more functions under the control of, or on behalf of, programs and/or services operating on computing device 902 and/or computing device 924. Systems such as service 930 and service 932 may include one or more computing devices such as those described herein to execute computer code to perform the one or more functions under the control of, or on behalf of, programs and/or services operating on computing device 902 and/or computing device 924.

For example, the computing resources provider 928 may provide a service, operating on service 930 to store data for the computing device 902 when, for example, the amount of data that the computing device 902 exceeds the capacity of storage device 910. In another example, the computing resources provider 928 may provide a service to first instantiate a virtual machine (VM) on service 932, use that VM to access the data stored on service 932, perform one or more operations on that data, and provide a result of those one or more operations to the computing device 902. Such operations (e.g., data storage and VM instantiation) may be referred to herein as operating “in the cloud,” “within a cloud computing environment,” or “within a hosted virtual machine environment,” and the computing resources provider 928 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 928 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 930 and service 932 may implement versions of various services (e.g., the service 912 or the service 926) on behalf of, or under the control of, computing device 902 and/or computing device 924. Such implemented versions of various services may involve one or more virtualization techniques so that, for example, it may appear to a user of computing device 902 that the service 912 is executing on the computing device 902 when the service is executing on, for example, service 930. As may also be contemplated, the various services operating within the computing resources provider 928 environment may be distributed among various systems within the environment as well as partially distributed onto computing device 924 and/or computing device 902.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a method comprising: accessing initial media stream being presented by a user device, wherein the initial media stream is associated with an initial media source; identifying initial media content from the initial media stream; applying a machine-learning model to the initial media stream to dynamically predict in real-time an interruption of the initial media content, wherein the interruption is predicted as the initial media stream continues to be presented; and presenting a different media stream associated with an alternative media source, wherein the different media stream is presented in response to the real-time predicted interruption.

Example 2 is the method of example(s) 1, wherein the machine-learning model was trained using transfer learning.

Example 3 is the method of any one of example(s) 1-2, wherein the alternative media source is associated with media content that substantially matches the initial media content of the initial media source.

Example 4 is the method of any one of example(s) 1-3, further comprising: applying the machine-learning model to the initial media stream to dynamically predict in real-time a conclusion of the interruption, wherein the conclusion of the interruption is predicted as the different media stream continues to be presented by the user device

Example 5 is the method of any one of example(s) 1-4, further comprising generating a notification to be presented on the user device upon conclusion of the interruption, wherein the notification includes an option to return to the initial media stream.

Example 6 is the method of any one of example(s) 1-4, further comprising reverting to presenting the initial media stream upon conclusion of the interruption.

Example 7 is the method of any one of example(s) 1-6, wherein presenting the different media stream includes initiating a timer, wherein the user device reverts to presenting the initial media stream when the timer expires.

Example 8 is the method of any one of example(s) 1-7, wherein predicting the interruption includes applying a data-smoothing algorithm to two or more outputs generated by the machine-learning model.

Example 9 is the method of any one of example(s) 1-8, wherein the initial media content includes music content, and wherein predicted real-time interruption includes non-music content.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 800 of FIG. 8). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
accessing initial media stream being presented by a user device, wherein the initial media stream is associated with an initial media source;
identifying initial media content from the initial media stream;
applying a machine-learning model to the initial media stream to dynamically predict in real-time an interruption of the initial media content, wherein the interruption is predicted as the initial media stream continues to be presented; and
presenting a different media stream associated with an alternative media source, wherein the different media stream is presented in response to the real-time predicted interruption.

2. The computer-implemented method of claim 1, wherein the machine-learning model was trained using transfer learning.

3. The computer-implemented method of claim 1, wherein the alternative media source is associated with media content that substantially matches the initial media content of the initial media source.

4. The computer-implemented method of claim 1, further comprising:
applying the machine-learning model to the initial media stream to dynamically predict in real-time a conclusion of the interruption, wherein the conclusion of the interruption is predicted as the different media stream continues to be presented by the user device.

5. The computer-implemented method of claim 1, further comprising:
generating a notification to be presented on the user device upon conclusion of the interruption, wherein the notification includes an option to return to the initial media stream.

6. The computer-implemented method of claim 1, further comprising:
reverting to presenting the initial media stream upon conclusion of the interruption.

7. The computer-implemented method of claim 1, wherein presenting the different media stream includes initiating a timer, wherein the user device reverts to presenting the initial media stream when the timer expires.

8. The computer-implemented method of claim 1, wherein predicting the interruption includes applying a data-smoothing algorithm to two or more outputs generated by the machine-learning model.

9. The computer-implemented method of claim 1, wherein the initial media content includes music content, and wherein predicted real-time interruption includes non-music content.

10. A system, comprising:
one or more processors; and
memory storing thereon instructions that, as a result of being executed by the one or more processors, cause the system to perform operations comprising:
accessing initial media stream being presented by a user device, wherein the initial media stream is associated with an initial media source;
identifying initial media content from the initial media stream;
applying a machine-learning model to the initial media stream to dynamically predict in real-time an interruption of the initial media content, wherein the interruption is predicted as the initial media stream continues to be presented; and
presenting a different media stream associated with an alternative media source, wherein the different media stream is presented in response to the real-time predicted interruption.

11. The system of claim 10, wherein the machine-learning model was trained using transfer learning.

12. The system of claim 10, wherein the alternative media source is associated with media content that substantially matches the initial media content of the initial media source.

13. The system of claim 10, wherein the instructions further cause the system to perform operations comprising:
applying the machine-learning model to the initial media stream to dynamically predict in real-time a conclusion of the interruption, wherein the conclusion of the interruption is predicted as the different media stream continues to be presented by the user device.

14. The system of claim 10, wherein the instructions further cause the system to perform operations comprising:
generating a notification to be presented on the user device upon conclusion of the interruption, wherein the notification includes an option to return to the initial media stream.

15. The system of claim 10, wherein the instructions further cause the system to perform operations comprising:
reverting to presenting the initial media stream upon conclusion of the interruption.

16. The system of claim 10, wherein presenting the different media stream includes initiating a timer, wherein the user device reverts to presenting the initial media stream when the timer expires.

17. The system of claim 10, wherein predicting the interruption includes applying a data-smoothing algorithm to two or more outputs generated by the machine-learning model.

18. The system of claim 10, wherein the initial media content includes music content, and wherein predicted real-time interruption includes non-music content.

19. A non-transitory, computer-readable storage medium storing thereon executable instructions that, as a result of being executed by one or more processors of a computer system, cause the computer system to perform operations comprising:
accessing initial media stream being presented by a user device, wherein the initial media stream is associated with an initial media source;
identifying initial media content from the initial media stream;
applying a machine-learning model to the initial media stream to dynamically predict in real-time an interruption of the initial media content, wherein the interruption is predicted as the initial media stream continues to be presented; and
presenting a different media stream associated with an alternative media source, wherein the different media stream is presented in response to the real-time predicted interruption.

20. The non-transitory, computer-readable storage medium of claim 19, wherein the machine-learning model was trained using transfer learning.

21. The non-transitory, computer-readable storage medium of claim 19, wherein the alternative media source is associated with media content that substantially matches the initial media content of the initial media source.

22. The non-transitory, computer-readable storage medium of claim 19, wherein the instructions further cause the system to perform operations comprising:
applying the machine-learning model to the initial media stream to dynamically predict in real-time a conclusion of the interruption, wherein the conclusion of the interruption is predicted as the different media stream continues to be presented by the user device.

23. The non-transitory, computer-readable storage medium of claim 19, wherein the instructions further cause the system to perform operations comprising:
generating a notification to be presented on the user device upon conclusion of the interruption, wherein the notification includes an option to return to the initial media stream.

24. The non-transitory, computer-readable storage medium of claim 19, wherein the instructions further cause the system to perform operations comprising:
reverting to presenting the initial media stream upon conclusion of the interruption.

25. The non-transitory, computer-readable storage medium of claim 19, wherein presenting the different media stream includes initiating a timer, wherein the user device reverts to presenting the initial media stream when the timer expires.

26. The non-transitory, computer-readable storage medium of claim 19, wherein predicting the interruption includes applying a data-smoothing algorithm to two or more outputs generated by the machine-learning model.

27. The non-transitory, computer-readable storage medium of claim 19, wherein the initial media content includes music content, and wherein predicted real-time interruption includes non-music content.
